(19) United States
(12) Patent Application Publication
(10) Pub. No.: US 2024/0224212 A1
(43) Pub. Date: Jul. 4, 2024

(54) TIMING ADVANCE TECHNIQUES FOR NON-TERRESTRIAL NETWORK HANDOVERS

(71) Applicant: QUALCOMM Incorporated, San Diego, CA (US)

(72) Inventors: Jing DAI, Beijing (CN); Chao WEI, Beijing (CN); Ruiming ZHENG, Beijing (CN); Qiaoyu LI, Beijing (CN); Hao XU, Beijing (CN); Peng CHENG, Beijing (CN)

(21) Appl. No.: 18/558,577

(22) PCT Filed: Jul. 31, 2021
(86) PCT No.: PCT/CN2021/109926

§ 371 Date: Nov. 2, 2023

(51) Int. Cl. H04W 56/00; H04B 7/06; H04W 36/00

(52) U.S. Cl. CPC H04W 56/0045; H04B 7/0626; H04W 36/0072

(57) ABSTRACT

Certain aspects of the present disclosure provide techniques for determining a timing advance (TA) for a handover in a network, such as a non-terrestrial network, A method that may be performed the UE includes receiving, from a source base station (BS), a handover command instructing the UE to hand over to a target BS, obtaining an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS, and transmitting, based on the handover command, one or more signals to the target BS using the TA for communicating with the target BS.

### INTRODUCTION

Aspects of the present disclosure relate to wireless communications, and more particularly, to techniques for determining timing advances for handovers in non-terrestrial networks (NTN).

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Certain aspects can be implemented in a method for wireless communication performed by a user equipment (UE). The method generally includes receiving, from a source base station (BS), a handover command instructing the UE to hand over to a target BS, obtaining an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS, and transmitting, based on the handover command, one or more signals to the target BS using the TA for communicating with the target BS.

Certain aspects can be implemented in a method for wireless communication performed by a source base station (BS). The method generally includes transmitting, to a user equipment (UE), a handover command instructing the UE to hand over to a target BS, transmitting a first reference signal to the UE, receiving a second reference signal from the target BS, and transmitting, to the UE, an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

Certain aspects can be implemented in a method for wireless communication performed by a target base station (BS). The method generally includes receiving an indication of a handover of a user equipment (UE) from a source BS to the target BS, transmitting a first reference signal to the UE, receiving a second reference signal from the source BS, and transmitting an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a wireless communication device and user equipment.

FIGS. 3A-3D depict various example aspects of data structures for a wireless communication network.

FIG. 4 illustrates an example non-terrestrial network.

FIGS. 5A and 5B illustrate different non-terrestrial network architectures.

FIGS. 6A-6C illustrate frequent and unavoidable handovers in a non-terrestrial network.

FIG. 7 is call flow diagram illustrating example operations for determining a timing advance for a handover in a network.

FIG. 8 illustrates a transmission timeline for determining the timing advance in FIG. 7.

FIG. 9 is another call flow diagram illustrating example operations for determining a timing advance for a handover in a network.

FIG. 10 illustrates a transmission timeline for determining the timing advance in FIG. 9.

FIG. 11 is another call flow diagram illustrating example operations for determining a timing advance for a handover in a network.

FIG. 12 illustrates a transmission timeline for determining the timing advance in FIG. 11.

FIGS. 13-15 illustrate example process flows for determining a timing advance for a handover in a network.

FIGS. 16 and 17 depict aspects of example communications devices.

### DETAILED DESCRIPTION

Aspects of the present disclosure provide apparatuses, methods, processing systems, and computer-readable mediums for determining a timing advance (TA) for a handover in a network.

For example, in certain types of networks, such as a non-terrestrial networks (NTNs), a large number of UEs may be actively camped on and communicating with a satellite base station (BS) at any given time within a particular cell or coverage area. In some cases, however, the satellite BS may be in a non-geostatic orbit around the Earth. As a result, the cell in which the satellite BS can provide coverage to the large number of UEs may move (e.g., relative to the large number of UEs) as the satellite BS orbits around the Earth. Consequently, the large number of UEs may frequently need to be handed off to other satellites to provide continuous service.

Generally, during a procedure to handover a UE from a source BS (e.g., a satellite BS that a UE is camped on) to a target BS (e.g., a satellite BS to which the UE will be handed over), the UE may transmit a random access channel (RACH) preamble to the target BS to allow the target BS to determine a TA for the UE to use to communicate with the target BS. However, the number of RACH preambles available for use in a given network configuration (e.g., a RACH preamble capacity) is limited, which presents an issue when large numbers of UEs need to be frequently handed over. Because the number of RACH preambles available for use is limited, collisions may occur between preamble transmissions when large numbers of UEs need to be frequently handed over. These collisions may result in the handover procedures failing, which may delay the UE from accessing the target BS. For example, when the handover procedure fails, the UE may not be able to obtain the TA from the target BS, preventing the UE from properly synchronizing uplink transmissions to the target BS to ensure that these uplink transmissions are properly received by the target BS.

Accordingly, aspects of the present disclosure provide techniques for determining and acquiring TAs for handovers in cases where large numbers of UEs are to be handed over. In some cases, instead of using a RACH procedure to obtain a TA from a target BS (e.g., via the transmission of a RACH preamble), techniques presented herein allow for the determination of the TA for communicating with the target BS using reference signals transmitted by the source BS and the target BS. For example, the techniques presented herein may involve determining a TA for the target BS based on a TA used for communicating with the source BS and based on a time difference between a first reference signal associated with the source BS and a second reference signal associated with the target BS.

Beneficially, the techniques described herein provide power savings at the UE since the UE may not be required to transmit a RACH preamble in order to obtain a TA for communicating with the target BS. Additionally, these techniques may provide power savings at the UU and reduce network congestions by avoiding failed RACH attempts. Moreover, because UEs may not be required to transmit these RACH preambles, these techniques help to avoid the RACH preamble capacity issue due to simultaneous RACH preamble transmission by a large number of UEs.

While the techniques presented herein are primarily described in relation to NTNs (e.g., handover from one satellite BS to another satellite BS), these techniques are also applicable to other scenarios involving handover of UEs. These other scenarios may include, for example, high-speed train scenarios in which large numbers of fast moving UEs may be handed over between stationary BSs and air-to-ground (ATG) networks in which large numbers of fast moving UEs in airplanes are handed over between BSs on the ground.

### Introduction to Wireless Communication Networks

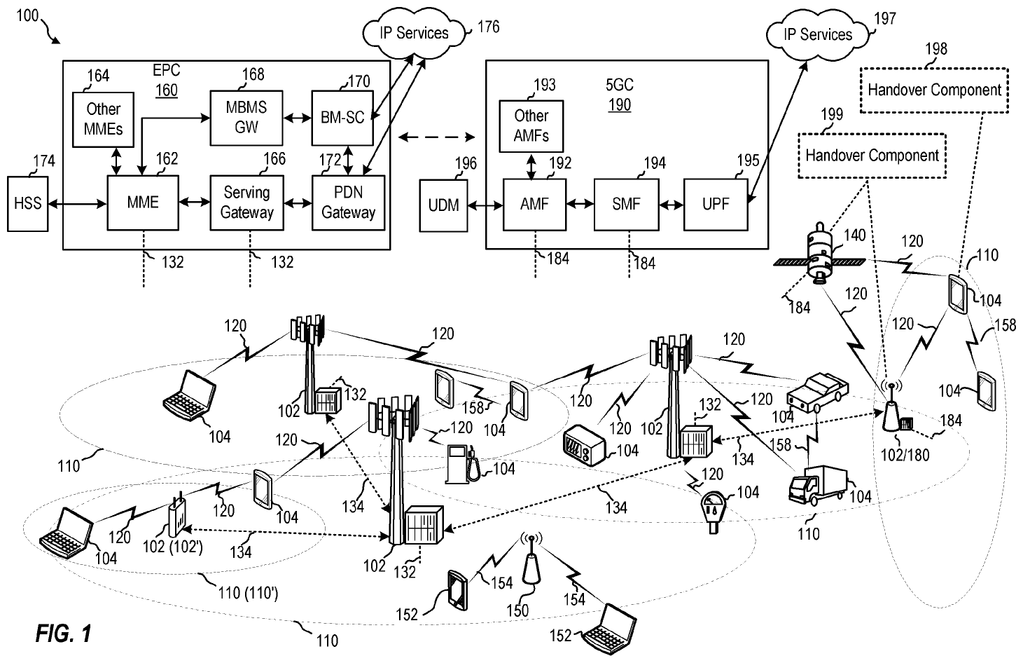

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 and satellite 140 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs may include and/or be referred to as a gNB, NodeB, eNB, ng-eNB (e.g., an eNB that has been enhanced to provide connection to both EPC 160 and 5GC 190), an access point, a base transceiver station, a radio BS, a radio transceiver, or a transceiver function, or a transmission reception point in various contexts.

BSs 102 and satellite 140 wirelessly communicate with UEs 104 via communications links 120. Similarly, in some cases, BSs 102 may also wirelessly communicate with the satellite 140 via a communication link 120. Each of BSs 102 may provide communication coverage for a respective geographic coverage area or 110, which may overlap in some cases. For example, small cell 102′ (e.g., a low-power BS) may have a coverage area 110′ that overlaps the coverage area 110 of one or more macrocells (e.g., high-power BSs).

The communication links 120 between BSs 102/satellite 140 and UEs 104 may include uplink (UL) (also referred to as reverse link) transmissions from a user equipment 104 to a BS 102 and/or downlink (DL) (also referred to as forward link) transmissions from a BS 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IOT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

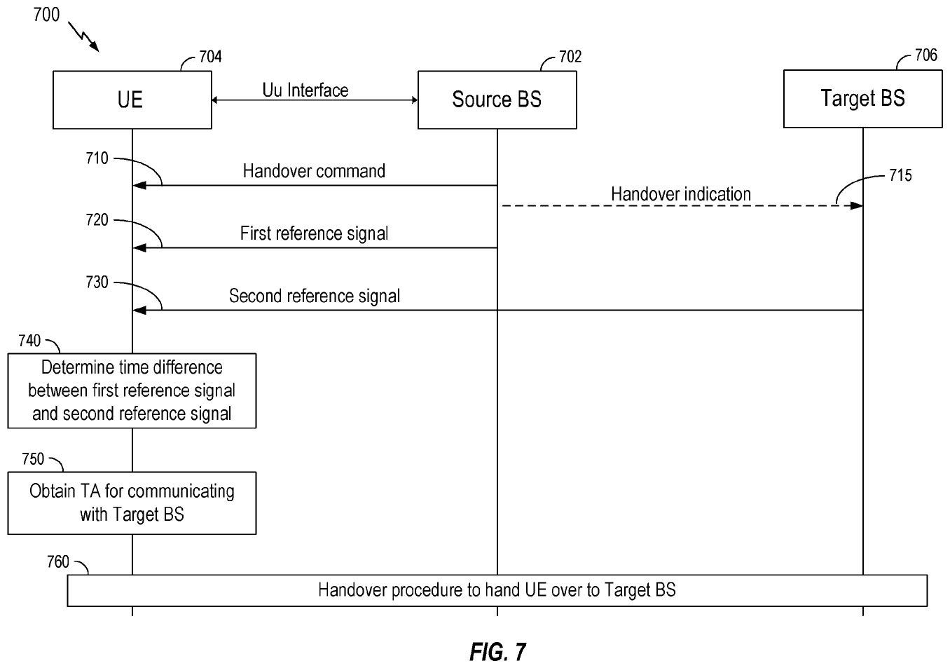

Wireless communication network 100 includes a handover component 199, which may be configured to perform the operations in one or more of FIGS. 7, 9, 11, 13, and 14, as well as other operations described herein for determining a TA for a handover in a network. As pictured, the handover component 199 may be part of the BS 102 or the satellite 140. Wireless communication network 100 further includes a handover component 198, which may be used configured to perform the operations in one or more of FIGS. 7, 9, 11, and 15, as well as other operations described herein for determining a TA for a handover in a network.

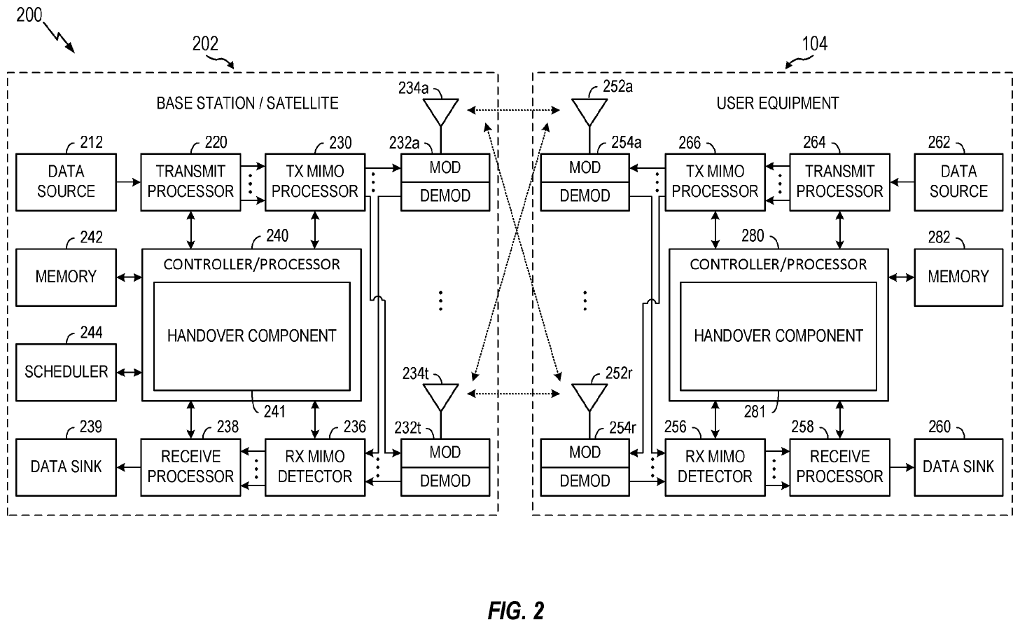

FIG. 2 depicts aspects of an example wireless communication device 202 and a UE 104. In some cases, the wireless communication device 202 may comprise the BS 102. In other cases, the wireless communication device may comprise the satellite 140.

Generally, wireless communication device 200 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, wireless communication device 200 may send and receive data between itself and user equipment 104.

Wireless communication device 200 includes controller/processor 240, which may be configured to implement various functions related to wireless communications. In the depicted example, controller/processor 240 includes a handover component 241, which may be representative of the handover component 199 of FIG. 1. Notably, while depicted as an aspect of controller/processor 240, the handover component 241 may be implemented additionally or alternatively in various other aspects of BS 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes a handover component 281, which may be representative of the handover component 198 of FIG. 1. Notably, while depicted as an aspect of controller/processor 280, the handover component 281 may be implemented additionally or alternatively in various other aspects of user equipment 104 in other implementations.

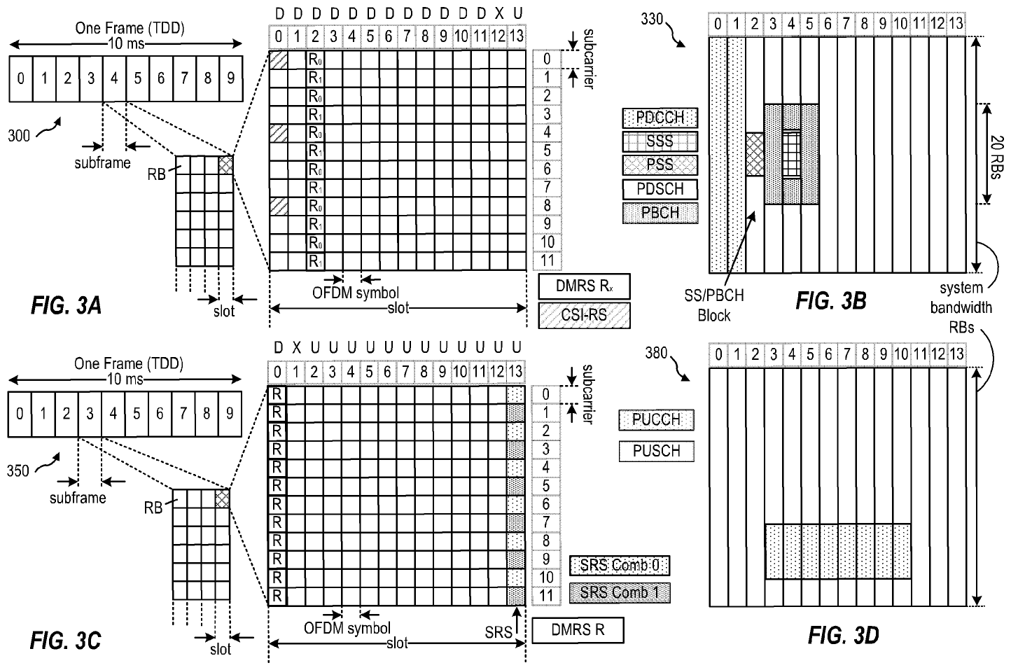

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to Non-Terrestrial Networks

In some cases, communication in a wireless communication network, such as the wireless communication network 100 illustrated in FIG. 1, may be facilitated by one or more non-terrestrial (NT) devices. In such cases, this wireless communication network may be referred to as a NT network (NTN). NT devices may include, for example, devices such as a space satellite (e.g., satellite 140 illustrated in FIG. 1), a balloon, a dirigible, an airplane, a drone, an unmanned aerial vehicle, and/or the like.

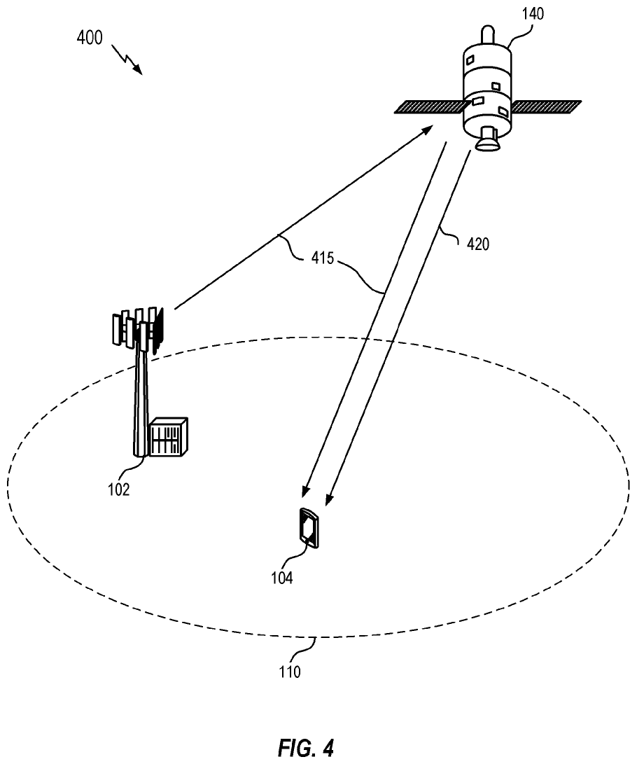

FIG. 4 illustrates an example of an NTN 400 including satellite 140, in which aspects of the present disclosure may be practiced. In some examples, the NTN 400 may implement aspects of the wireless communication network 100. For example, the NTN 400 may include BS 102, UE 104, and satellite 140. BS 102 may serve a coverage area or cell 110 in cases of a terrestrial network, and satellite 140 may serve the coverage area or cell 110 in cases of an NTN. Some NTNs may employ airborne platforms (e.g., a drone or balloon) and/or space borne platforms (e.g., a satellite).

The satellite 140 may communicate with the BS 102 and UE 104 as part of wireless communications in the NTN 400. In cases of a terrestrial network, the UE 104 may communicate with the BS 102 over a communication link (e.g., communication link 120 in FIG. 1). In the case of NTN wireless communications, the satellite 140 may be the serving cell for the UE 104 via a communication links 420 (e.g., communication link 120 in FIG. 1). In certain aspects, the satellite 140 may act as a relay for the BS 102 and the UE 104, relaying both data transmission and control signaling 415.

The UE 104 may determine to connect to the satellite 140 using a random access (RA) procedure (e.g., a four-step RA procedure or a two-step RA procedure). The initiation of the RA procedure may begin with the transmission of a RA preamble (e.g., an NR preamble for RA) by the UE 104 to the satellite 140 or BS 102. The UE 104 may transmit the RA preamble on a physical random access channel (PRACH). In some PRACH designs, there may be no estimation or accounting for the RTD or the frequency shift associated with NTNs. In certain networks, such as terrestrial NR networks (e.g., 5G NR), SSBs transmitted by a cell are transmitted on the same frequency interval (e.g., occupying the same frequency interval). In NTN, a satellite may use multiple antennas to form multiple narrow beams and the beams may operate on different frequency intervals to mitigate interference among the beams.

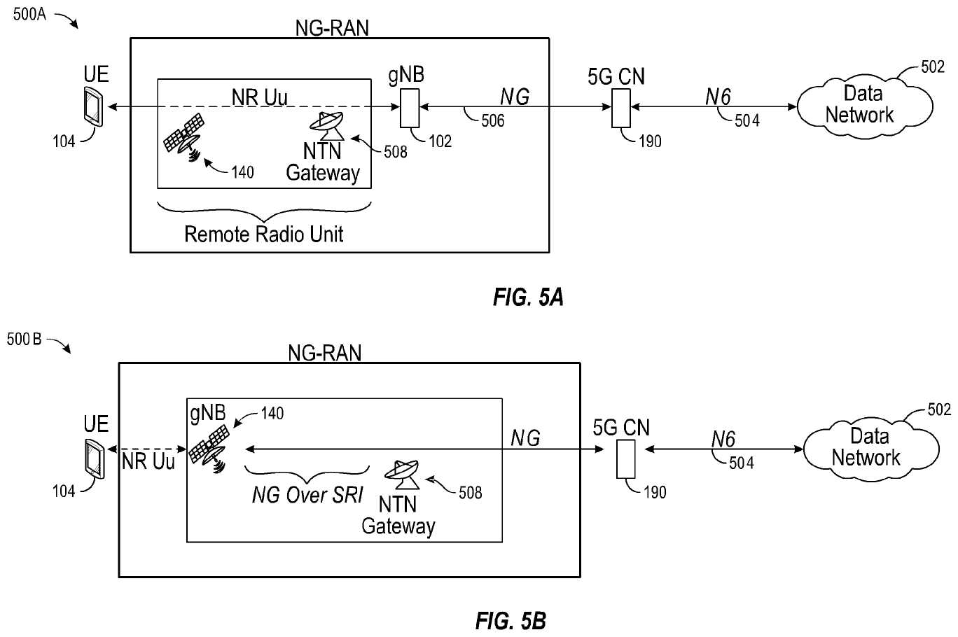

In some cases, different architectures may exist for NTNs, such as a transparent satellite based NTN architecture and a regenerative satellite based NTN architecture. An example of the transparent satellite based NTN architecture is illustrated in FIG. 5A while an example of the regenerative satellite based NTN architecture is illustrated in FIG. 5B. In some cases, the NTN architectures shown in FIGS. 5A and 5B may be implemented in the NTN 400 shown in FIG. 4.

In general, the transparent satellite based NTN architecture (e.g., also known as a bent-pipe satellite architecture, such as depicted in FIG. 5A) involves the satellite 140 receiving a signal from a BS 102 and relaying the signal to a UE 104 or another BS 102, or vice-versa. In the regenerative satellite based NTN architecture (such as depicted in FIG. 5B), satellite 140 may be configured to relay signals like the bent-pipe transponder or satellite, but may also use on-board processing to perform other functions, such as demodulating a received signal, decoding a received signal, re-encoding a signal to be transmitted, or modulating the signal to be transmitted, or a combination thereof.

For example, as shown in FIG. 5A, in a transparent satellite based NTN architecture 500A, communication between a UE 104 and a data network (DN) 502 may begin with data being sent from the DN 502 over a communication link 504 to user plane function (UPF) in a 5G core network (5G CN), such as the UPF 195 in 5GC 190 illustrated in FIG. 1. In some cases, the communication link 504 between the DN 502 and the UPF in the 5GC 190 may be associated with an N6 interface. Thereafter, the data may be forwarded from the 5GC 190 to BS 102 via a communication link 506 associated with an NG interface. The data may then be sent by the BS 102 to the UE 104 on a new radio (NR) Uu interface via an NTN gateway 508 and satellite 140. For example, the NTN gateway 508 may receive the data from the BS 102 and may forward the data to the satellite 140 on a feeder link via a satellite radio interface (SRI). The SRI on the feeder link is the NR Uu interface. Thereafter, the satellite 140 may perform radio frequency filtering, frequency conversion, and amplification on the received data before relaying the data to the UE 104 on a service link. Hence, the satellite 140 in the transparent satellite based NTN architecture 500A merely repeats the data on the NR-Uu radio interface from the feeder link (e.g., between the NTN gateway 508 and the satellite 140) to the service link (e.g., between the satellite 140 and the UE 104) and vice versa. In other words, the data is un-changed by the satellite 140 and is simply relayed to the UE 104.

In the regenerative satellite based NTN architecture 500B illustrated in FIG. 5B, the data from the DN 502 may be sent from the 5G CN directly to the satellite 140 via NTN gateway 508 without first being processed by BS 102. For example, the NTN gateway 508 may send the data to the satellite 140 on a feeder link that implements an SRI interface. After receiving the data, the satellite 140 may perform radio frequency filtering, frequency conversion and amplification as well as demodulation/decoding, switch and/or routing, coding/modulation. This is effectively equivalent to having all or part of BS 102 functions (e.g. gNB) on board the satellite 140. Thereafter, the satellite 140 transmits the data to the UE 104 on an NR-Uu radio interface via a service link between the UE 104 and the satellite 140

### Aspects Related to Timing Advance Techniques for Handovers in Non-Terrestrial Networks

As discussed above, wireless communications may be performed in a non-terrestrial network (NTN) (e.g., NTN 400) between satellites (e.g., satellite 140) and other wireless communication devices, such as user equipments (UEs) (e.g., UE 104). Within an NTN, these satellites may orbit Earth in geostatic orbits and non-geostatic orbits. Satellites with a geostatic orbit may have a position in space that is static relative to a fixed position on earth while satellites with non-geostatic orbits may have positions that are non-static relative to the fixed position on Earth. In other words, satellites in non-geostatic orbit may move with high speed relative to a fixed position on Earth. As a consequence the coverage areas or cells (e.g., cell 110 illustrated in FIGS. 1 and 4) associated with satellites in non-geostatic orbit may also move with high speed relative to the fixed position on Earth, leading to frequent and unavoidable handover for both stationary and non-stationary UEs within a coverage area or cell of a satellite.

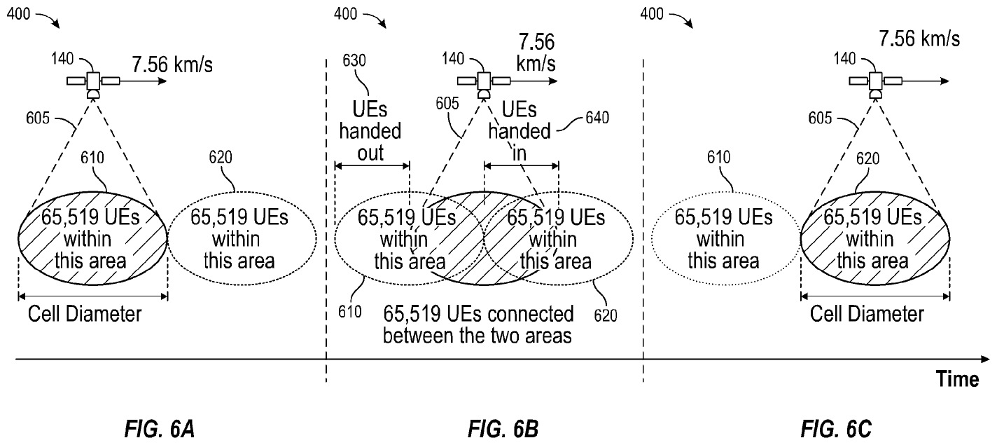

FIGS. 6A-6C illustrate these frequent and unavoidable handovers an NTN, such as the NTN 400. Each of FIGS. 6A-6C illustrate a different instances in time as the satellite 140 orbits in space, traversing from a first cell location 610 on Earth to a second cell location 620 on Earth. For example, as shown in FIG. 6A, the satellite 140 may initially serve a cell 605 in first cell location 610 while traveling at a high rate of speed (e.g., 7.56 km/s). The cell 605 may have varying diameters (e.g., depending on a particular implementation) and, as a result, cover varying areas. In FIG. 6A, the diameter of the cell 605 may be 1000 km, equating to a cell area of approximately 785,000 km², and may serve approximately 65,519 UEs in one example.

As time progresses, the satellite 140 continues to orbit around the Earth. As a result the cell 605 moves to a location on Earth in between the first cell location 610 and the second cell location 620, as shown in FIG. 6B. Because the cell 605 continues to move locations on Earth due to the orbit of the satellite 140, a first number of UEs 630 originally included within the cell 605 in the first cell location 610 in FIG. 6A may no longer be within a coverage area of the cell 605 in FIG. 6B and, thus, may be handed over to another satellite. Similarly, due to the orbit of the satellite 140, a second number of UEs 640 from second cell location 620 that were not originally included within the cell 605 in FIG. 6A may now be within the coverage area of the cell 605 in FIG. 6B and, thus, may be handed over from another satellite to the satellite 140.

Thereafter, as illustrated in FIG. 6C, the satellite 140 continues to orbit around the Earth, resulting in the cell 605 moving to the second cell location 620. As a result, all remaining UEs that were originally served by the satellite 140 in the first cell location 610 are handed over to another satellite. Similarly, any UEs within the second cell location 620 in FIG. 6B that were not previously served by the satellite 140 are now handed over to the satellite 140 in FIG. 6C.

As can be seen in the example illustrated in FIGS. 6A-6C, as the cell 605 of the satellite 140 traverses from the first cell location 610 to the second cell location 620, approximately 65,519 UEs may be handed over to and from the satellite 140. Further, assuming the cell diameter size of 1000 km and an orbit speed of the satellite 140 of 7.56 km/s, handover of these 65,519 UEs may occur about every 2.2 minutes. Table 1, below, illustrates various average handover times and handover rates for different cell diameter sizes, assuming 65,519 connected UEs in this example.

TABLE 1
Average handover rate and time for a given cell diameter size

| | | | | | Average | |
|---|---|---|---|---|---|---|
| | | Average | | Time to | “hand- | Average |
| Cell | Approximate | UE | Satellite | HO all | out” | HO Rate |
| Diameter | Cell Area | density | speed | UEs in | rate | (in + out) |
| (km) | (km²) | (UE/km²) | (km/s) | cell (s) | (UE/s) | (UEs/s) |
| 50 | 1964 | 33.36 | 7.56 | 6.61 | 9912 | 19824 |
| 100 | 7854 | 8.34 | | 13.23 | 4952 | 9904 |
| 250 | 49087 | 1.33 | | 33.07 | 1981 | 3962 |
| 500 | 196000 | 0.33 | | 66.14 | 991 | 1982 |
| 1000 | 785000 | 0.08 | | 132.28 | 495 | 990 |

Different types of handover procedures exist, such as the normal handover procedure involving the four-step and two-step RACH procedures discussed above as well as a conditional handover procedure. In some cases, a source BS (e.g., satellite 140) may trigger a normal handover procedure by sending a radio resource control (RRC) reconfiguration message to a UE (e.g., UE 104) being handed over. The RRC reconfiguration message may include information required to access a target BS (e.g., another satellite 140) of a target cell, such as target cell identifier (ID) and a new cell-radio network temporary identifier (C-RNTI). Additionally, a set of dedicated (e.g., contention-free) radio access channel (RACH) resources (e.g., preambles) may also be indicated in the RRC reconfiguration message, which may be associated with at least one of synchronization signal block (SSBs) or channel state information reference signals (CSI-RSs) of the target BS.

Upon receiving the RRC reconfiguration message, the UE may transmit a RACH preamble to the target BS. The purpose of triggering the UE to transmit the preamble is to allow the target BS to determine timing advance (TA) for the UE, which may be indicated to the UE in a random access response (RAR) message. However, for frequent handovers with a large amount of UEs, such as the scenario illustrated in FIGS. 6A-6C, a capacity of preambles may become an issue and collisions between UEs may be difficult to avoid either for contention-based or contention-free RACH resources (e.g., preambles). In other words, the number of preambles that may be used to perform RACH procedures are limited and, thus, when a large number of UEs are frequently being handed over, there may inevitably be collisions between preambles used by different UE.

These collisions may result in the normal handover procedures performed in NTNs failing, which may delay the UE from accessing the target BS. For example, when the handover procedure fails, the UE in an NTN may not be able to obtain the TA from the target BS, preventing the UE from properly synchronizing uplink transmissions to the target BS to ensure that these uplink transmissions are properly received by the target BS.

There may also be issues with acquiring a TA for use in an NTN when using a conditional handover procedure. For example, when using a conditional handover procedure, a source BS may transmit an RRC reconfiguration message to the UE, activating a conditional handover and configuring the UE with certain handover conditions for triggering the conditional handover. In some cases, conditional handover conditions for NTNs may include, for example, measurement-based triggering, location (e.g., UE and satellite) triggering, time- or timer-based triggering, timing advance value based triggering, and elevation angles of source and target cells based triggering.

In response to receiving the RRC reconfiguration message from the source BS, the UE may then immediately respond to the source BS with an RRC reconfiguration complete message (e.g., which is normally transmitted to the target BS after a normal handover is completed), acknowledging the conditional handover. Thereafter, the UE may evaluate the conditional handover conditions and, if one of the conditional handover conditions is satisfied, the UE may detach from the source cell and synchronize with a target cell. However, the conditional handover procedure may not involve the UE transmitting a RACH preamble to the target BS, which would allow the target BS to determine a TA for the UE. As such, in scenarios involving conditional handovers in NTNs, it is unclear how a target BS may determine the TA for a UE that is being handed over to the target BS. In some cases, the target BS may determine the TA for the UE with the assistance of Global Navigation Satellite System (GNSS) location service to pin-point a location of a UE; however, not all UEs support GNSS location services.

Accordingly, aspects of the present disclosure provide techniques for determining and acquiring TAs for handovers in NTNs. In some cases, these techniques may involve determining a TA for a target BS based on a TA used for communicating with a source BS and based on a time difference between a first reference signal associated with the source BS and a second reference signal associated with the target BS. These techniques may allow for a TA to be more-accurately determined for cases involving a conditional handover when GNSS location services are not supported. Additionally, these techniques may provide power savings at the UE since the UE may not be required to transmit a RACH preamble in order to obtain a TA for communicating with the target BS. Moreover, because UEs may not be required to transmit these RACH preambles, these techniques help to avoid the RACH preamble capacity issue due to simultaneous RACH preamble transmission by a large amount of UEs.

### Example Call Flow Illustrating Operations for Determining a Time Advance for a Handover in a Non-Terrestrial Network by a User Equipment

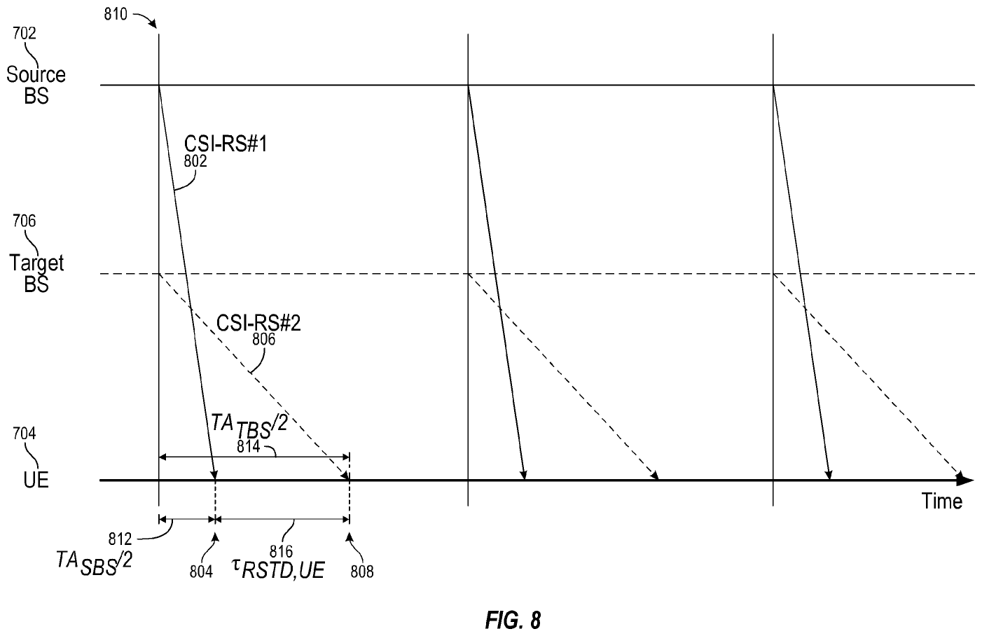

FIG. 7 is a call flow diagram illustrating example operations 700 between a source BS 702, UE 704, and a target BS 706 for determining, by the UE 704, a timing advance for a handover in a network. For ease of understanding, operations 700 will be described below in combination with a transmission timeline illustrated in FIG. 8. In some cases, the network may comprise a non-terrestrial network (NTN) in which non-terrestrial BSs (NTBSs) operate with ideal or fine synchronization according to an atomic clock.

Further, in some cases, the source BS may comprise a first NTBS in the NTN (e.g., NTN 400 illustrated in FIGS. 4 and 6), such as satellite 140 illustrated in FIGS. 1, 4, and 5A-5B. Additionally, the target BS 706 may comprise a second NTBS in the NTN, such as another satellite 140 in NTN 400. Additionally, the UE 604 may be an example of the UE 104 illustrated in FIGS. 1 and 4. Further, as shown, a Uu interface may be established to facilitate communication between the BS 602 and UE 604, however, in other aspects, a different type of interface may be used.

While aspects presented below will primarily describe the source BS 702 and target BS 702 as non-terrestrial BSs or satellites, in other cases, the source BS 702 comprises a NTBS in an NTN (e.g., satellite 140 in NTN 400) while the target BS 706 comprises a BS in a terrestrial network, such as BS 102 illustrated in the wireless communication network 100 of FIG. 1. In other cases, the source BS 702 comprises a BS in a terrestrial network (e.g., BS 102) while the target BS 706 comprises an NTBS in an NTN, such as satellite 140 in NTN 400. In yet other cases, both the source BS 702 and the target BS 706 may comprise a BSs in a terrestrial network, such as two different BSs 102 in the wireless communication network 100 illustrated in FIG. 1. When the source BS 702 and the target BS 706 may comprise BSs in a terrestrial network, the operations presented below may be applicable to scenarios in which large numbers of fast-moving UEs are handed off between stationary BSs, such as high-speed train scenarios.

As shown in FIG. 7, operations 700 may begin with the UE 704 receiving, from the source BS 702, a handover command instructing the UE 704 to handover to the target BS 706. Prior to receiving the handover command, the UE 704 may be camped on and communicating with the source BS 702 using a TA for communicating with the source BS 702 (e.g., TA_{SBS}). Additionally, as shown at 715, the source BS 702 may also (optionally) transmit a handover indication to the target BS 706, indicating that the UE 704 will be handed over to the target BS 706.

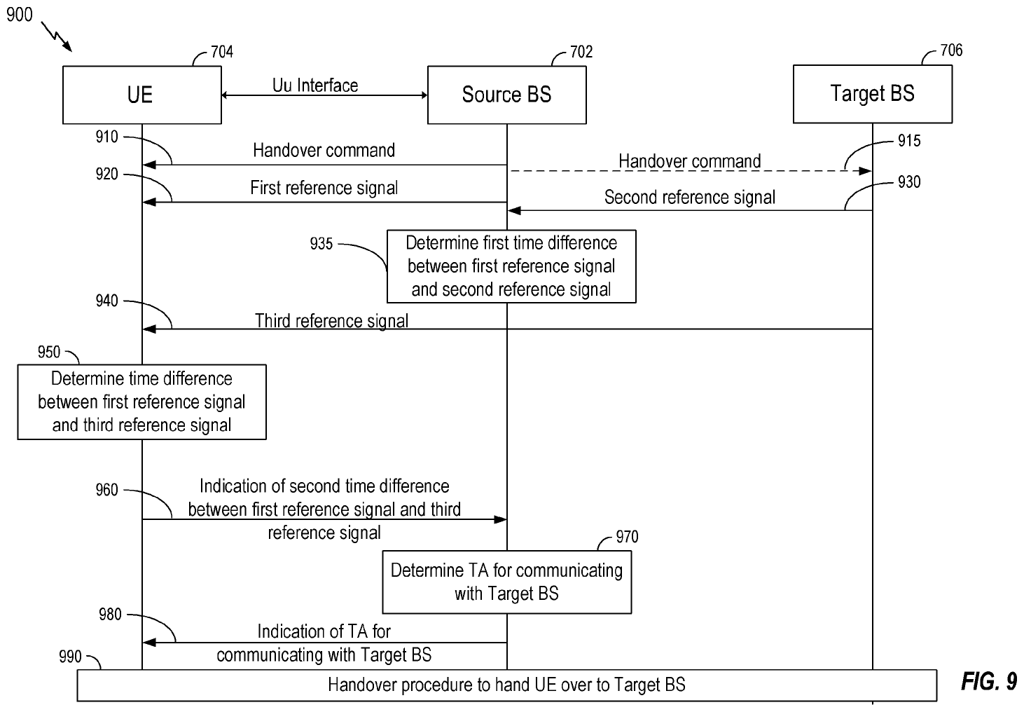

Thereafter, the UE 704 may then perform one or more actions to obtain a TA for communicating with the target BS 706 (e.g., TA_{TBS}). In some cases, the TA for communicating with the target BS 706 may be based, at least in part, on a TA used for communicating with the source BS and a first time difference between a first reference signal associated with the source BS and a second reference signal associated with the target BS. For example, in the scenario where source BS 702 and target BS 706 operate with ideal or fine synchronization according to an atomic clock, the UE 704 may perform the one or more actions to determine the TA for communicating with the target BS 706 itself, as described below, as opposed to receiving an indication of the TA for communicating with the target BS 706 from either the source BS 702 or the target BS 706 (e.g., which will be described below with reference to FIGS. 9-10 and 11-12, respectively).

More specifically, for example, to determine the TA for communicating with the target BS 706, the UE 704 receives, at 720, the first reference signal from the source BS 702 at a first receive time. The UE also receives, at 730, the second reference signal from the target BS 706 at a second receive time. In some cases, the source BS 702 may transmit a message to the UE, including an indication of the second reference signal associated with the target BS 706. The indication of the second reference signal associated with the target BS 706 may include an indication of time and frequency resources to receive the second reference signal from target BS 706. In some cases, the message comprises at least one of the handover command (e.g., transmitted to the UE at 710), a media access control-control element (MAC-CE), or downlink control information (DCI). Additionally, in some cases, the message further includes information triggering the UE 704 to determine the first time difference between the first reference associated with the source BS 702 and the second reference signal associated with the target BS, as discussed below.

In some cases, the first reference signal comprises one of a synchronization signal block (SSB), a channel state information reference signal (CSI-RS), or a positioning reference signals (PRS). The second reference signal may also comprise one of an SSB, a CSI-RS, or a PRS. For example, as shown in FIG. 8, the UE 704 receives a first CSI-RS 802 from the source BS 702 at a first receive time 804. The first CSI-RS 802 may comprise the first reference signal received by the UE 704 at 720 in FIG. 7. Similarly, the UE 704 also receives a second CSI-RS 806 from the target BS 706 at a second receive time 808. The second CSI-RS 806 may comprise the second reference signal received by the UE 704 at 730 in FIG. 7. Further, as shown, the first CSI-RS 802 and the second CSI-RS 806 may both be transmitted (e.g., by the source BS 702 and the target BS 706, respectively) at a same transmit time 810.

Additionally, as shown in FIG. 8, a time difference 812 between the transmit time 810 of the first CSI-RS 802 from the source BS 702 and the first receive time 804 of the first CSI-RS 802 may be represented as half of the TA for communicating with the source BS 702 (e.g., TA_{SBS}/2). Similarly, as shown, a time difference 814 between the transmit time 810 of the second CSI-RS 806 from the target BS 706 and the second receive time 808 of the second CSI-RS 806 may be represented as half of the TA for communicating with the target BS 706 (e.g., TA_{TBS}/2). Because the UE 704 is unaware of the transmit time 810 of the first CSI-RS 802 and the second CSI-RS 806, the UE 704 may be able to determine the TA for communicating with the target BS 706 (TA_{TBS}) based on the TA for communicating with the source BS 702 (TA_{SBS}) and based on a time difference 816 between the first receive time 804 of the first CSI-RS 802 and the second receive time 808 of the second CSI-RS 806, known as a reference signal time difference (T_{RSTD,UE}).

For example, returning back to FIG. 7, as shown in block 740, the UE 704 determines the first time difference (e.g., time difference 816, T_{RSTD,UE} in FIG. 8) between the first reference signal (e.g., the first CSI-RS 802 in FIG. 8) associated with the source BS 702 and the second reference signal (e.g., the second CSI-RS 806 in FIG. 8) associated with the target BS 706 based on the first receive time (e.g., first receive time 804 in FIG. 8) and the second receive time (e.g., second receive time 808 in FIG. 8).

As noted above, the UE 704 may be triggered to determine the first time difference (e.g., time difference 816, T_{RSTD,UE} in FIG. 8) based on information received in a message from the source BS 702. In some cases, the information that triggers the UE 704 to determine the first time difference may include a group identifier associated with a group of UEs, including the UE 704. In some cases, the group identifier depends on a transmission beam associated with the source BS 702. For example, the group identifier, and associated group of UEs, may be associated with a beam that is near an edge of a cell associated with the source BS 702. Accordingly, by indicating the group identifier associated with the group of UEs (e.g., including the UE 704), only those UEs that are close to the edge of the cell associated with the source BS 702 may be triggered to determine the first time difference for an impending handover to the target BS 706.

In some cases, the UE 704 may determine the first time difference between the first reference signal associated with the source BS and the second reference signal associated with the target BS by determining a number of slots between the first receive time and the second receive time based on a subcarrier spacing associated with at least one of the source BS or the target BS. In some cases, since a distance between the UE 704 and the source BS 702 and target BS 706 is significant and can cause propagation delay across multiple slots, the number of slots between the first receive time associated with the first reference signal and the second time associated with the second reference signal may be needed to convert a standards definition of RSTD, which is subframe based, into τ_{RSTD, UE}, which is slot based, to avoid ambiguities in determining the TA for communicating with the target BS 706.

Accordingly, the UE may determine the number of slots between the first receive time and the second receive time by converting the first time difference between the first reference signal and the second reference signal (e.g., the time difference between the first receive time and the second receive time) based on

$$\frac{16}{{2}^{μ}} \cdot {T}_{s} = \frac{16}{{2}^{μ}} \cdot 64 \cdot {T}_{c}$$

for a normal TA granularity, where μ is a subcarrier spacing associated with at least one of the source BS or the target BS, Tₛ is equal to 32.552 ns, and T_{c} is equal to 0.509 ns. Generally, the duration

$$\frac{16}{{2}^{μ}} \cdot {T}_{s} = \frac{16}{{2}^{μ}} \cdot 64 \cdot {T}_{c}$$

is less than one slot, and can be regarded as a delta in addition to the duration of the number of slots between the first receive time and the second receive time (e.g., the time difference between the first receive time and the second receive time). In some cases, the number of slots between the first receive time and the second receive time may depend on a height of the source BS 702 and the target BS 706.

Thereafter, as shown in block 750 in FIG. 7, the UE 704 may obtain the TA for communicating with target BS 706 (e.g., TA_{TBS}) using, for example, Equation 1, below.

$$\frac{T {A}_{T B S}}{2} = \frac{T {A}_{S B S}}{2} + {τ}_{RSTD , UE} \to T {A}_{T B S} = T {A}_{S B S} + 2 \cdot {τ}_{RSTD , UE} \qquad ( 1 )$$

As shown in Equation 1 and as discussed above, TA_{TBS} is the TA for communicating with the target BS 706, TA_{SBS} is the TA for communicating with the source BS 702, and τ_{RSTD, UE} is the time difference (e.g., time difference 816, τ_{RSTD, UE} in FIG. 8) between the first reference signal (e.g., the first CSI-RS 802 in FIG. 8) associated with the source BS 702 and the second reference signal (e.g., the second CSI-RS 806 in FIG. 8) associated with the target BS 706.

In some cases, a transmit time (e.g., transmit time 810 in FIG. 8) may not be the same for the first reference signal (e.g., the first CSI-RS 802 in FIG. 8) associated with the source BS 702 and the second reference signal (e.g., the second CSI-RS 806 in FIG. 8) associated with the target BS 706. In other words, there may be cases where the first reference signal (e.g., the first CSI-RS 802 in FIG. 8) associated with the source BS 702 is transmitted at a different transmit time from the second reference signal (e.g., the second CSI-RS 806 in FIG. 8) associated with the target BS 706. In this case, the UE 704 may apply an additional offset to the first time difference (e.g., time difference 816, T_{RSTD,UE} in FIG. 8) between the first reference signal (e.g., the first CSI-RS 802 in FIG. 8) associated with the source BS 702 and the second reference signal (e.g., the second CSI-RS 806 in FIG. 8) associated with the target BS 706, as shown in Equation 2.

$$T {A}_{T B S} = T {A}_{S B S} + 2 \cdot ( {τ}_{RSTD , UE} + {offset}_{RS \# - to - RS \#2} ) \qquad ( 2 )$$

In some cases, the offset may be non-zero and pre-configured or indicated to the UE 704 by the source BS 702. Further, the offset accounts for a difference in transmission times between the first reference signal and the second reference signal. Further, in some cases, the offset may be less than a threshold, which may depend on at least one of a speed of the source BS 702 or a speed of the target BS 706.

Thereafter, as illustrated in block 760, the source BS 702, the UE 704, and the target BS 706 may perform a handover procedure, based on the handover command received at 710, to hand the UE 704 over to the target BS 706. In some cases, during or after the handover procedure initiated based on the handover command, the UE 704 may transmit one or more signals or channels to the target BS using the TA for communicating with the target BS 706. In some cases, the one or more signals may include, for example, an RRC reconfiguration complete message, a channel state information (CSI) report, or other uplink signals.

### Example Call Flow Illustrating Operations for Determining a Time Advance for a Handover in a Non-Terrestrial Network by a Source Base Station

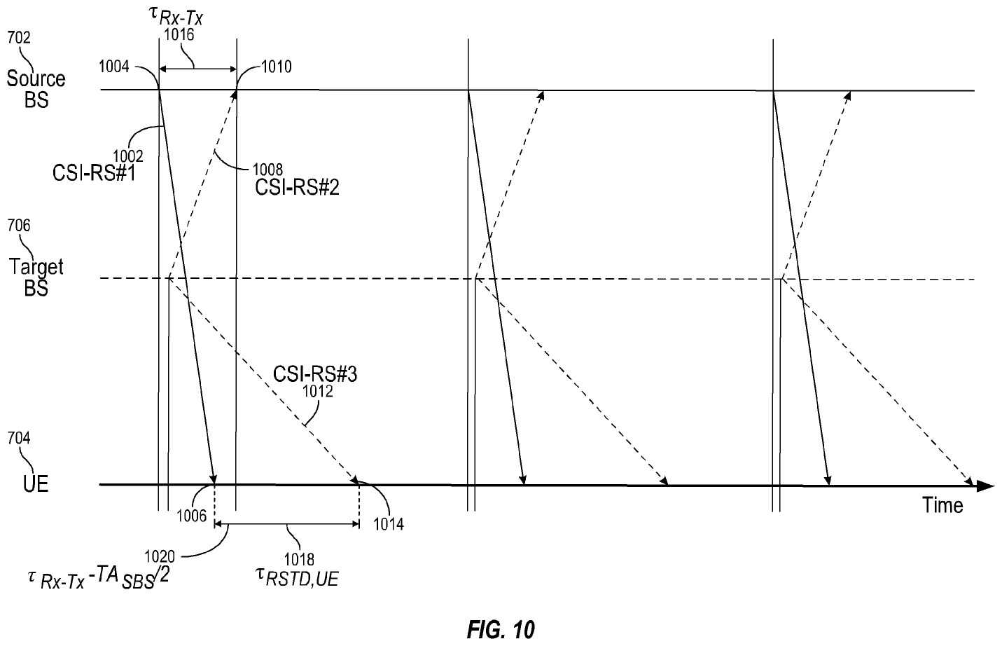

FIG. 9 is a call flow diagram illustrating example operations 900 between the source BS 702, the UE 704, and the target BS 706 for determining, by the source BS 702, a timing advance for a handover in a network. For ease of understanding, operations 900 will be described below in combination with a transmission timeline illustrated in FIG. 10. In some cases, the network may comprise a NTN in which NTBSs (e.g., the source BS 702 and/or the target BS 706) do not operate with ideal or fine synchronization (e.g., in contrast to FIGS. 7 and 8). In such cases, as will be described below, the source BS 702 may also need to determine a time difference associated with reference signals from the target BS 706 in order to determine the TA for communicating with the target BS 706.

As illustrated, operations 900 may begin with the UE 704 receiving, from the source BS 702, a handover command instructing the UE 704 to hand over to the target BS 706. Prior to receiving the handover command, the UE 704 may be camped on and communicating with the source BS 702 using a TA for communicating with the source BS 702 (e.g., TA_{SBS}). Additionally, as shown at 915, the source BS 702 may also (optionally) transmit a handover indication to the target BS 706, indicating that the UE 704 will be handed over to the target BS 706.

Thereafter, the source BS 702 may then perform one or more actions to determine a TA for communicating with the target BS 706 (e.g., TA_{TBS}). In some cases, the TA for communicating with the target BS 706 may be based, at least in part, on a TA used for communicating with the source BS 702 and a first time difference between a transmit time of a first reference signal transmitted by the source BS 702 and a receive time of a second reference signal received by the source BS 702 from the target BS 706. Further, as described below, the TA for communicating with the target BS 706 may also be based on a time of flight (ToF) between the source BS 702 and the target BS 706 as well as a second time difference between a receive time of the first reference signal at the UE 704 and a receive time of a third reference signal associated with the target BS 706 at the UE 704.

To be able to determine the TA for communicating with the target BS 706, as shown at 920, the source BS 702 transmits the first reference signal to the UE 704. Further, at 930, the source BS 702 receives the second reference signal from the target BS 706. Thereafter, as shown in block 935, the source BS 702 determines the first time difference between the transmit time of the first reference signal and the receive time of the second reference signal. In some cases, using techniques similar to those described above with respect to FIGS. 7 and 8, the source BS 702 may determine the first time difference between the transmit time of the first reference signal and the receive time of the second reference signal by determining, based on a subcarrier spacing associated with at least one of the source BS or the target BS, a number of slots between the transmit time of the first reference signal and the receive time of the second reference signal. Additionally, in some cases, the source BS 702 may apply an offset to the first time difference. In such cases, the TA for communicating with the target BS 706 may be based further on the applied offset.

Further, the source BS 702 may also transmit a message to the UE 704, including an indication of the third reference signal associated with the target BS 706. The indication of the third reference signal associated with the target BS 706 may include an indication of time and frequency resources to receive the third reference signal from target BS 706. In some cases, the message comprises at least one of the handover command (e.g., transmitted to the UE at 910), a MAC-CE, or DCI. Additionally, in some cases, the message further includes information configured to cause the UE 704 to determine a second time difference between the first reference associated with the source BS 702 and the third reference signal associated with the target BS 706.

Based on the indication of the third reference signal associated with the target BS 706, the UE 704 receives the third reference signal associated with the target BS 706 as shown at 940 in FIG. 9. In some cases, the third reference signal associated with the target BS 706 may be the same reference signal as the second reference signal associated with the target BS 706. In other words, there may be a zero offset between the second reference signal associated with the target BS 706 and the third reference signal associated with the target BS 706.

Thereafter, in block 950, the UE 704 determines a second time difference between a receive time of the first reference signal associated with the source BS 702 at the UE 704 and a receive time of the third reference signal associated with the target BS 706 at the UE 704. In some cases, as noted above, the UE 704 may determine the second time difference by determining, based on a subcarrier spacing associated with at least one of the source BS 702 or the target BS 706, a number of slots between the receive time of the first reference signal associated with the source BS 702 at the UE 704 and the receive time of a third reference signal associated with the target BS 706 at the UE 704. Additionally, in some cases, the UE 704 may apply an offset to the second time difference. Thereafter, as illustrated at 960, the UE 704 transmits an indication of the second time difference to the source BS 702.

In some cases, the first reference signal associated with the source BS 702 comprises one of an SSB, a CSI-RS, or a PRS. The second reference signal associated with the target BS 706 received by the source BS 702 may also comprise one of an SSB, a CSI-RS, or a PRS. Similarly, the third reference signal associated with the target BS 706 received by the UE 704 may also comprise one of an SSB, a CSI-RS, or a PRS.

Accordingly, for example, as shown in FIG. 10, the source BS 702 transmits a first CSI-RS 1002 (e.g., the first reference signal in FIG. 9) at a transmit time 1004, which may be received by the UE 704 at a receive time 1006. Further, as shown, the target BS 706 transmits a second CSI-RS 1008 (e.g., the second reference signal in FIG. 9), which may be received by the source BS 702 at receive time 1010. In some cases, because the source BS 702 and the target BS 706 do not operate with ideal synchronization, a transmission time of the second CSI-RS 1008 may not be the same as the transmit time 1004 of the first CSI-RS 1002. Further, as shown in FIG. 10, the target BS 706 also transmits a third CSI-RS 1012 (e.g., the third reference signal in FIG. 9), which may be received by the UE 704 at receive time 1014.

Additionally, FIG. 10 shows a time difference 1016 (e.g., τ_{Rx-Tx}) between the receive time 1010 of the second CSI-RS 1008 at the source BS 702 and the transmit time 1004 of the first CSI-RS 1002 by the source BS 702 (e.g., the first time difference determined in block 935 by the source BS 702 in FIG. 9). FIG. 10 also shows a time difference 1018 (e.g., τ_{RSTD,UE}) between the receive time 1006 of the first CSI-RS 1002 at the UE 704 and the receive time 1014 of the third CSI-RS 1012 at the UE 704 (e.g., the second time difference determined in block 950 by the UE 704 in FIG. 9). FIG. 10 also shows a time difference 1020, representing the time in between the receive time 1006 of the first CSI-RS 1002 at the UE 704 and the receive time 1010 of the second CSI-RS 1008 at the source BS 702. For example, the receive time 1006 at which the first CSI-RS 1002 is received by the UE 704 may be half of the TA used for communicating with the source BS 702 (e.g., TA_{SBS}/2). Accordingly, the time difference 1020 may be equal to

$${τ}_{R x - T x} - \frac{T {A}_{S B S}}{2} ,$$

where, as noted above, τ_{Rx-Tx} is the difference in time between the receive time 1010 of the second CSI-RS 1008 at the source BS 702 and the transmit time 1004 of the first CSI-RS 1002 by the source BS 702.

Returning now to FIG. 9, as shown at 970, the source BS 702 determines the TA for communicating with the target BS 706 according to either one of Equations 3 or 4. Equation 4 represents a simplified version of Equation 3.

$$\frac{T {A}_{T B S}}{2} = {T}_{o F} ( SBS , TBS ) + {τ}_{RSTD , UE} - [ {τ}_{R x - T x} - \frac{T {A}_{S B S}}{2} ] \qquad ( 3 )$$

$$T {A}_{T B S} = T {A}_{S B S} + 2 \cdot [ {T}_{o F} ( S BS , TBS ) + {τ}_{RSTD , UE} - {τ}_{R x - T x} ] \qquad ( 4 )$$

Accordingly, as can be seen in Equations 3 and 4, the TA for communicating with the target BS 706 (e.g., TA_{TBS}) is based on the TA used for communicating with the source BS 702 (e.g., TA_{SBS}), the ToF between the source BS 702 and the target BS 706, the first time difference between the transmit time of the first reference signal and the receive time of the second reference signal (e.g., time difference 1016, τ_{Rx-Tx} in FIG. 10), and the second time difference between the receive time of the first reference signal at the UE 704 and the receive time of the third reference signal associated with the target BS 706 at the UE 704 (e.g., τ_{RSTD,UE}).

Thereafter, as shown at 980, the source BS 702 transmits an indication of the TA for communicating with the target BS 706, which is received by the UE 704. In some cases, the indication of the TA for communicating with the target BS 706 may include a value of the actual TA for communicating with the target BS 706. In other cases, the indication of the TA for communicating with the target BS 706 may comprise an indication of the first time difference between the transmit time of the first reference signal and the receive time of the second reference signal (e.g., time difference 1016, τ_{Rx-Tx} in FIG. 10). For example, this would allow the UE 704 to use either of Equations 3 or 4 to determine the TA for communicating with the target BS 706 since the UE 704 would already know the TA used for communicating with the source BS 702 (e.g., TA_{SBS}) as well as the second time difference between the receive time of the first reference signal at the UE 704 and the receive time of the third reference signal associated with the target BS 706 at the UE 704 (e.g., τ_{RSTD,UE}). In this case, the UE 704 may also be preconfigured with the ToF between the source BS 702 and the target BS 706 or may look the ToF up in a standards document or look up table.

In other cases, the indication of the TA for communicating with the target BS 706 may comprise a value representing a difference between the ToF between the source BS 702 and the target BS 706 and an indication of the first time difference between the transmit time of the first reference signal and the receive time of the second reference signal. In other words, the value represents T_{oF}(SBS, TBS)−τ_{Rx-Tx}.

Thereafter, as shown 990, the source BS 702, the UE 704, and the target BS 706 perform, based on the handover command, a handover procedure to hand the UE 704 over to the target BS 706. In some cases, during or after the handover procedure initiated based on the handover command, the UE 704 may transmit one or more signals or channels to the target BS using the TA for communicating with the target BS 706. In some cases, the one or more signals may include, for example, an RRC reconfiguration complete message, a CSI report, or other uplink signals.

### Example Call Flow Illustrating Operations for Determining a Time Advance for a Handover in a Non-Terrestrial Network by a Target Base Station

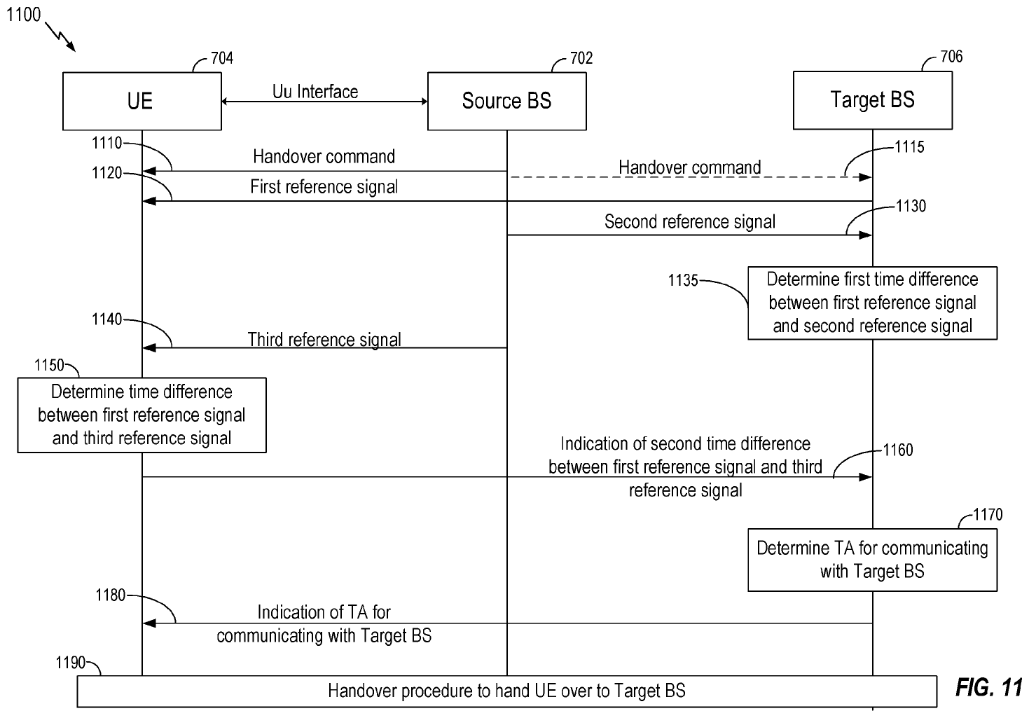

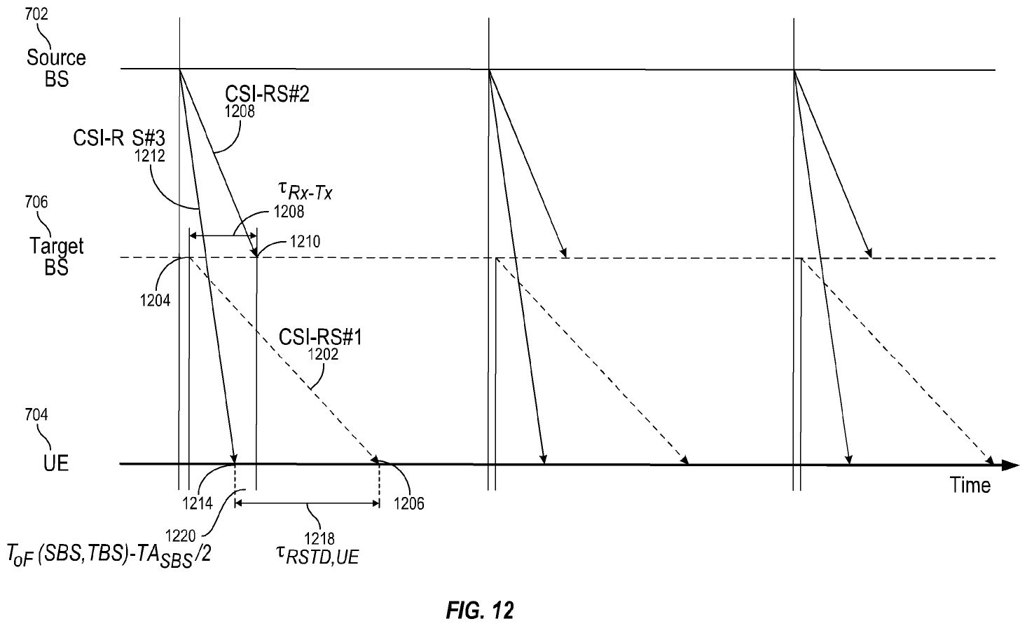

FIG. 11 is a call flow diagram illustrating example operations 1100 between the source BS 702, the UE 704, and the target BS 706 for determining, by the target BS 706, a timing advance for a handover in a network. For ease of understanding, operations 1100 will be described below in combination with a transmission timeline illustrated in FIG. 12. In some cases, the network may comprise a NTN in which NTBSs (e.g., the source BS 702 and/or the target BS 706) do not operate with ideal or fine synchronization (e.g., in contrast to FIGS. 7 and 8). In such cases, as will be described below, the target BS 706 may also need to determine a time difference associated with reference signals from the source BS 702 in order to determine the TA for communicating with the target BS 706.

As illustrated, operations 1100 may begin with the UE 704 receiving, from the source BS 702, a handover command instructing the UE 704 to hand over to the target BS 706. Prior to receiving the handover command, the UE 704 may be camped on and communicating with the source BS 702 using a TA for communicating with the source BS 702 (e.g., TA_{SBS}). Additionally, as shown at 1115, the source BS 702 may also (optionally) transmit a handover indication to the target BS 706, indicating that the UE 704 will be handed over to the target BS 706.

Thereafter, the target BS 706 may then perform one or more actions to determine a TA for communicating with the target BS 706 (e.g., TA_{TBS}). In some cases, the TA for communicating with the target BS 706 may be based, at least in part, on a TA used for communicating with the source BS 702 and a first time difference between a transmit time of a first reference signal transmitted by the target BS 706 and a receive time of a second reference signal received by the target BS 706 from the source BS 702. Further, as described below, the TA for communicating with the target BS 706 may also be based on a time of flight (ToF) between the source BS 702 and the target BS 706 as well as a second time difference between a receive time of the first reference signal at the UE 704 and a receive time of a third reference signal associated with the source BS 702 at the UE 704.

In some cases, the source BS 702 may transmit a message to the UE 704, including an indication of the first reference signal associated with the target BS 706. The indication of the first reference signal associated with the target BS 706 may include an indication of time and frequency resources to receive the first reference signal from target BS 706. In some cases, the message comprises at least one of the handover command (e.g., transmitted to the UE at 1110), a MAC-CE, or DCI. Accordingly, as shown at 1120, the target BS 706 may transmit the first reference signal to the UE 704. In some cases, the UE 704 may receive the first reference signal from the target BS 706 via the time and frequency resources indicated by the source BS 702. In some cases, the message further includes information configured to cause the UE 704 to determine the second time difference between the first reference associated with the target BS 706 and the third reference signal associated with the source BS 702, as described below.

Further, at 1130, the target BS 706 receives the second reference signal from the source BS 702. Thereafter, as shown in block 1135, the target BS 706 determines the first time difference between the transmit time of the first reference signal and the receive time of the second reference signal. In some cases, using techniques similar to those described above with respect to FIGS. 7 and 8, the target BS 706 may determine the first time difference between the transmit time of the first reference signal and the receive time of the second reference signal by determining, based on a subcarrier spacing associated with at least one of the source BS or the target BS, a number of slots between the transmit time of the first reference signal and the receive time of the second reference signal. Additionally, in some cases, the target BS 706 may apply an offset to the first time difference. In such cases, the TA for communicating with the target BS 706 may be based further on the applied offset.

As shown at 1140, the UE 704 receives the third reference signal associated with the source BS 702. In some cases, the third reference signal associated with the source BS 702 may be the same reference signal as the second reference signal associated with the source BS 702. In other words, there may be a zero offset between the second reference signal associated with the source BS 702 and the third reference signal associated with the source BS 702.

Thereafter, in block 1150, the UE 704 determines the second time difference between a receive time of the first reference signal associated with the target BS 706 at the UE 704 and a receive time of the third reference signal associated with the source BS 702 at the UE 704. In some cases, as noted above, the UE 704 may determine the second time difference by determining, based on a subcarrier spacing associated with at least one of the source BS 702 or the target BS 706, a number of slots between the receive time of the first reference signal associated with the target BS 706 at the UE 704 and the receive time of the third reference signal associated with the source BS 702 at the UE 704. Additionally, in some cases, the UE 704 may apply an offset to the second time difference. Thereafter, as illustrated at 1160, the UE 704 transmits an indication of the second time difference to the target BS 706.

In some cases, the first reference signal associated with the target BS 706 comprises one of an SSB, a CSI-RS, or a PRS. The second reference signal associated with the source BS 702 received by the target BS 706 may also comprise one of an SSB, a CSI-RS, or a PRS. Similarly, the third reference signal associated with the source BS 702 received by the UE 704 may also comprise one of an SSB, a CSI-RS, or a PRS.

Accordingly, for example, as shown in FIG. 12, the target BS 706 transmits a first CSI-RS 1202 (e.g., the first reference signal in FIG. 11) at a transmit time 1204, which may be received by the UE 704 at a receive time 1206. Further, as shown, the source BS 702 transmits a second CSI-RS 1208 (e.g., the second reference signal in FIG. 11), which may be received by the target BS 706 at receive time 1210. In some cases, because the source BS 702 and the target BS 706 do not operate with ideal synchronization, a transmission time of the second CSI-RS 1208 may not be the same as the transmit time 1204 of the first CSI-RS 1202. Further, as shown in FIG. 12, the source BS 702 also transmits a third CSI-RS 1212 (e.g., the third reference signal in FIG. 11), which may be received by the UE 704 at receive time 1214.

Additionally, FIG. 12 shows a time difference 1216 (e.g., τ_{Rx-Tx}) between the receive time 1210 of the second CSI-RS 1208 at the target BS 706 and the transmit time 1204 of the first CSI-RS 1202 by the target BS 706 (e.g., the first time difference determined in block 1135 by the target BS 706 in FIG. 11). FIG. 12 also shows a time difference 1218 (e.g., τ_{RSTD,UE}) between the receive time 1206 of the first CSI-RS 1202 at the UE 704 and the receive time 1214 of the third CSI-RS 1212 at the UE 704 (e.g., the second time difference determined in block 1150 by the UE 704 in FIG. 11). FIG. 12 also shows a time difference 1220, which is equal to the ToF between the source BS 702 and the target BS 706 minus half of the TA used for communicating with the source BS 702. In other words, the time difference 1220 is equal to

$${T}_{o F} ( S BS , TBS ) - \frac{T {A}_{S B S}}{2} .$$

Returning now to FIG. 11, as shown at 1170, the target BS 706 determines the TA for communicating with the target BS 706 according to either one of Equations 5 or 6. Equation 6 represents a simplified version of Equation 5.

$$\frac{T {A}_{T B S}}{2} = {τ}_{R x - T x} + {τ}_{RSTD , UE} - [ {T}_{o F} ( S BS , TBS ) - \frac{T {A}_{S B S}}{2} ] \qquad ( 5 )$$

$$T {A}_{T B S} = T {A}_{S B S} + 2 \cdot [ {τ}_{R x - T x} + {τ}_{RSTD , UE} - {T}_{o F} ( S BS , TBS ) ] \qquad ( 6 )$$

Accordingly, as can be seen in Equations 5 and 6, the TA for communicating with the target BS 706 (e.g., TA_{TBS}) is based on the TA used for communicating with the source BS 702 (e.g., TA_{SBS}), the ToF between the source BS 702 and the target BS 706, the first time difference between the transmit time of the first reference signal and the receive time of the second reference signal (e.g., time difference 1216, τ_{Rx-Tx} in FIG. 12), and the second time difference between the receive time of the first reference signal at the UE 704 and the receive time of the third reference signal associated with the source BS 702 at the UE 704 (e.g., τ_{RSTD,UE}).

Thereafter, as shown at 1180, the target BS 706 transmits an indication of the TA for communicating with the target BS 706, which is received by the UE 704. In some cases, the source BS 702 may instead transmit the indication of the TA for communicating with the target BS 706. For example, in this case, after determining the TA for communicating with the target BS 706, the target BS 706 may transmit the indication of the TA for communicating with the target BS 706 to the source BS 702, which may then transmit the indication of the TA for communicating with the target BS 706 to the UE 704.

In some cases, the indication of the TA for communicating with the target BS 706 may include a value of the actual TA for communicating with the target BS 706. In other cases, the indication of the TA for communicating with the target BS 706 may comprise an indication of the first time difference between the transmit time of the first reference signal and the receive time of the second reference signal (e.g., time difference 1216, τ_{Rx-Tx} in FIG. 12). For example, this would allow the UE 704 to use either of Equations 5 or 6 to determine the TA for communicating with the target BS 706 since the UE 704 would already know the TA used for communicating with the source BS 702 (e.g., TA_{SBS}) as well as the second time difference between the receive time of the first reference signal at the UE 704 and the receive time of the third reference signal associated with the source BS 702 at the UE 704 (e.g., τ_{RSTD,UE}). In this case, the UE 704 may also be preconfigured with the ToF between the source BS 702 and the target BS 706 or may look the ToF up in a standards document or look up table.

In other cases, the indication of the TA for communicating with the target BS 706 may comprise a value representing a difference between the ToF between the source BS 702 and the target BS 706 and an indication of the first time difference between the transmit time of the first reference signal and the receive time of the second reference signal. In other words, the value represents τ_{Rx-Tx}−T_{oF}(SBS, TBS).

Thereafter, as shown 1190, the source BS 702, the UE 704, and the target BS 706 perform, based on the handover command, a handover procedure to hand the UE 704 over to the target BS 706. In some cases, during or after the handover procedure initiated based on the handover command, the UE 704 may transmit one or more signals or channels to the target BS using the TA for communicating with the target BS 706. In some cases, the one or more signals may include, for example, an RRC reconfiguration complete message, a CSI report, or other uplink signals.

### Example Methods for Determining a Time Advance for a Handover in a Network

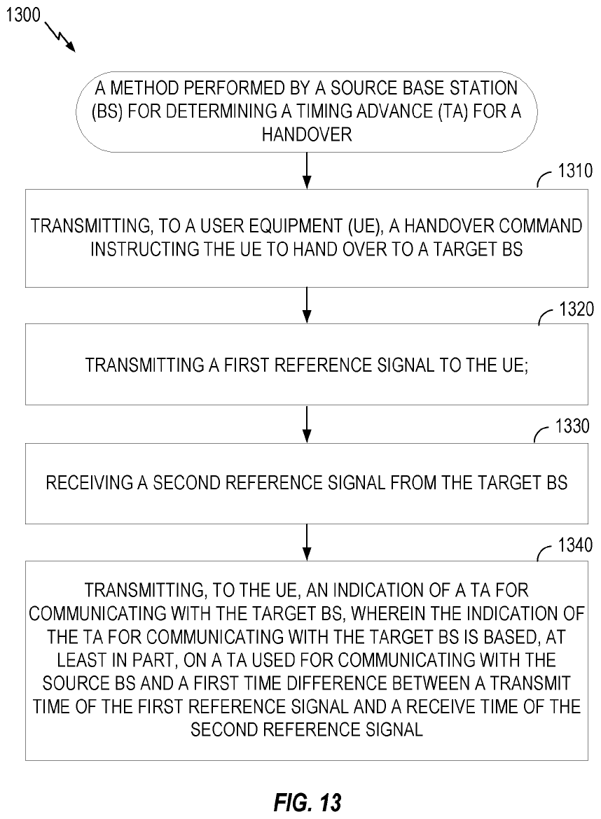

FIG. 13 is a flow diagram illustrating example operations 1300 for wireless communication. The operations 1300 may be performed, for example, by a source BS (e.g., such as the satellite 140 or BS 102 in the wireless communication network 100 of FIG. 1 and/or the source BS 702 illustrated in FIGS. 7-12) for determining a timing advance for communicating with a target BS. The operations 1300 may be implemented as software components that are executed and run on one or more processors (e.g., controller/processor 240 of FIG. 2). Further, the transmission and reception of signals by the BS in operations 1300 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the handover component 241) obtaining and/or outputting signals.

Operations 1300 begin in block 1310 with transmitting, to a user equipment (UE), a handover command instructing the UE to hand over to a target BS.

In block 1320, the source BS transmits a first reference signal to the UE.

In block 1330, the source BS receives a second reference signal from the target BS.

In block 1340, the source BS transmits, to the UE, an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

In some cases, the indication of the TA for communicating with the target BS is further based on a time of flight (ToF) between the source BS and the target BS.

In some cases, the first reference signal comprises one of synchronization signal blocks (SSBs), channel state information reference signals (CSI-RSs), or positioning reference signals (PRSs). In some cases, the second reference signal comprises one of an SSB, a CSI-RS, or a PRS.

In some cases, operations 1300 further include receiving, from the UE, an indication of a second time difference between a receive time of the first reference signal at the UE and a receive time of a third reference signal associated with the target BS at the UE. In this case, the indication of the TA for communicating with the target BS is based further on the second time difference.

In some cases, the indication of the TA for communicating with the target BS comprises an indication of the first time difference between the transmit time of the first reference signal and the receive time of the second reference signal. In some cases, the indication of the TA for communicating with the target BS comprises a value representing a difference between a time of flight (ToF) between the source BS and the target BS and an indication of the first time difference between the transmit time of the first reference signal and the receive time of the second reference signal.

In some cases, operations 1300 further include transmitting a message to the UE including an indication of a third reference signal associated with the target BS. In some cases, the message comprises at least one of: the handover command, a media access control-control element (MAC-CE), or downlink control information (DCI). In some cases, the message further includes information configured to cause the UE to determine a second time difference between the first reference and the third reference signal associated with the target BS. In some cases, the information configured to cause the UE to determine the first time difference includes a group identifier associated with a group of UEs, including the UE, and the group identifier depends on a transmission beam associated with the source BS.

In some cases, operations 1300 may further include determining the first time difference between the transmit time of the first reference signal and the receive time of the second reference signal.

In some cases, operations 1300 further include applying an offset to the first time difference, wherein the indication of the TA for communicating with the target BS is based further on the applied offset.

In some cases, determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.

In some cases, the source BS comprises a first non-terrestrial BS (NTBS) in a non-terrestrial network (NTN) and the target BS comprises a second NTBS in the NTN, such as the satellite 140 illustrated in FIGS. 1, 4, 5, and 6. In some cases, the source BS comprises a non-terrestrial BS (NTBS) in a non-terrestrial network (NTN) and the target BS comprises a BS in a terrestrial network. In some cases, the source BS comprises a BS in a terrestrial network (e.g., BS 102 illustrated in FIG. 1) and the target BS comprises a non-terrestrial BS (NTBS) in a non-terrestrial network (NTN) (e.g., satellite 140 illustrated in FIG. 1). In some cases, the source BS comprises a BS in a terrestrial network and the target BS comprises a BS in a terrestrial network.

In some cases, operations 1300 further include performing, based on the handover command, a handover procedure to hand the UE over to the target BS.

Note that FIG. 13 is just one example of a method, and other methods including fewer, additional, or alternative steps are possible consistent with this disclosure.

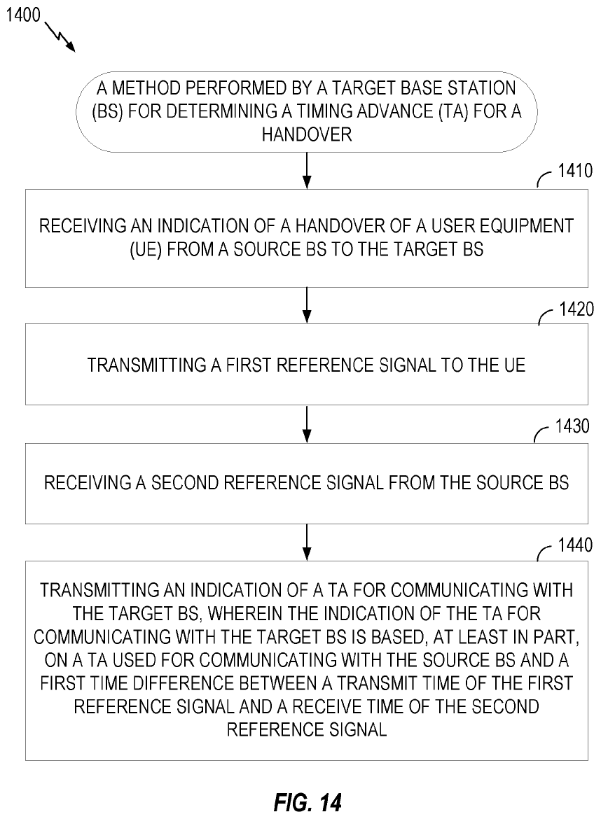

FIG. 14 is a flow diagram illustrating example operations 1400 for wireless communication. The operations 1400 may be performed, for example, by a target BS (e.g., such as the satellite 140 or BS 102 in the wireless communication network 100 of FIG. 1 and/or the target BS 706 illustrated in FIGS. 7-12) for determining a timing advance for communicating with the target BS. The operations 1400 may be implemented as software components that are executed and run on one or more processors (e.g., controller/processor 240 of FIG. 2). Further, the transmission and reception of signals by the BS in operations 1400 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the handover component 241) obtaining and/or outputting signals.

Operations 1400 begin in block 1410 with receiving an indication of a handover of a user equipment (UE) from a source BS to the target BS.

In block 1420, the target BS transmits a first reference signal to the UE.

In block 1430, the target BS receives a second reference signal from the source BS.

In block 1440, the target BS transmits an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

In some cases, the indication of the TA for communicating with the target BS is further based on a time of flight (ToF) between the source BS and the target BS

In some cases, the first reference signal comprises one of synchronization signal blocks (SSBs), channel state information reference signals (CSI-RSs), or positioning reference signals (PRSs). In some cases, the second reference signal comprises one of an SSB, a CSI-RS, or a PRS.

In some cases, operations 1400 further include receiving, from the UE, an indication of a second time difference between a receive time of the first reference signal at the UE and a receive time of a third reference signal associated with the source BS at the UE, wherein the indication of the TA for communicating with the target BS is based further on the second time difference.

In some cases, the indication of the TA for communicating with the target BS comprises an indication of the first time difference between the transmit time of the first reference signal and the receive time of the second reference signal. In some cases, the indication of the TA for communicating with the target BS comprises a value representing a difference between a time of flight (ToF) between the source BS and the target BS, and an indication of the first time difference between the transmit time of the first reference signal and the receive time of the second reference signal.

In some cases, operations 1400 further include determining the first time difference between the transmit time of the first reference signal and the receive time of the second reference signal.

In some cases, operations 1400 further include applying an offset to the first time difference, wherein the indication of the TA for communicating with the target BS is based further on the applied offset.

In some cases, determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.

In some cases, the source BS comprises a first non-terrestrial BS (NTBS) in a non-terrestrial network (NTN) and the target BS comprises a second NTBS in the NTN. In some cases, the source BS comprises a non-terrestrial BS (NTBS) in a non-terrestrial network (NTN) and the target BS comprises a BS in a terrestrial network. In some cases, the source BS comprises a BS in a terrestrial network and the target BS comprises a non-terrestrial BS (NTBS) in a non-terrestrial network (NTN). In some cases, the source BS comprises a BS in a terrestrial network and the target BS comprises a BS in a terrestrial network.

In some cases, operations 1400 further include performing, based on the handover command, a handover procedure to hand the UE over to the target BS.

Note that FIG. 14 is just one example of a method, and other methods including fewer, additional, or alternative steps are possible consistent with this disclosure.

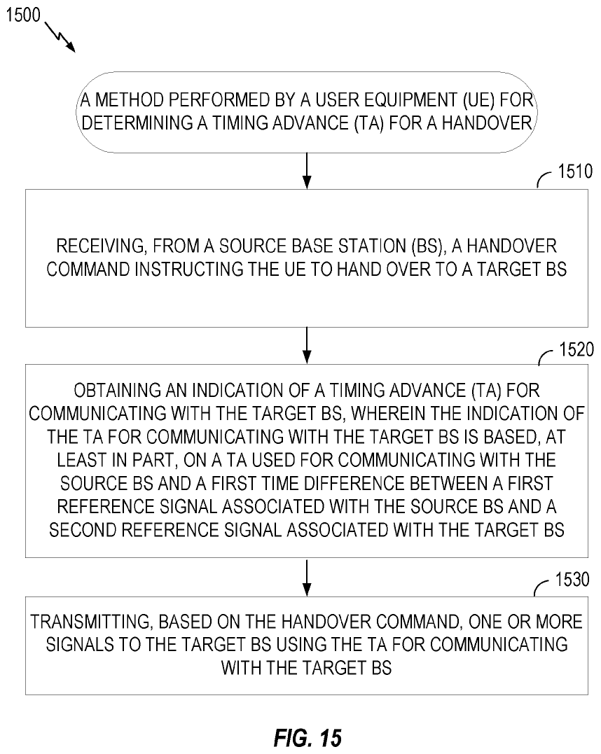

FIG. 15 is a flow diagram illustrating example operations 1500 for wireless communication, in accordance with certain aspects of the present disclosure. The operations 1500 may be performed, for example, by a UE (e.g., such as the UE 104 in the wireless communication network 100 of FIG. 1 and/or the UE 704 illustrated in FIGS. 7-12) for determining a timing advance for communicating with a target BS. In some cases, the operations 1500 may be complementary to the operations 1300 performed by the source BS and the operations 1400 performed by the target BS. The operations 1500 may be implemented as software components that are executed and run on one or more processors (e.g., controller/processor 280 of FIG. 2). Further, the transmission and reception of signals by the UE in operations 1500 may be enabled, for example, by one or more antennas (e.g., antennas 252 of FIG. 2). In certain aspects, the transmission and/or reception of signals by the UE may be implemented via a bus interface of one or more processors (e.g., controller/processor 280, including the handover component 281) obtaining and/or outputting signals.

Operations 1500 begin in block 1510 with the UE receiving, from a source base station (BS), a handover command instructing the UE to hand over to a target BS.

In block 1520, the UE obtains an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS.

In block 1530, the UE transmits, based on the handover command, one or more signals to the target BS using the TA for communicating with the target BS.

In some cases, the first reference signal comprises one of synchronization signal blocks (SSBs), channel state information reference signals (CSI-RSs), or positioning reference signals (PRSs). In some cases, the second reference signal comprises one of SSBs, CSI-RSs, or PRSs.

In some cases, operations 1500 further include receiving the first reference signal from the source BS at a first receive time. In some cases, operations 1500 further include receiving the second reference signal from the target BS at a second receive time. In some cases, operations 1500 further include determining the first time difference between the first reference signal associated with the source BS and the second reference signal associated with the target BS based on the first receive time and the second receive time.

In some cases, determining the first time difference between the first reference signal associated with the source BS and the second reference signal associated with the target BS based on the first receive time and the second receive time comprises determining a number of slots between the first receive time and the second receive time based on a subcarrier spacing associated with at least one of the source BS or the target BS.

In some cases, operations 1500 further include applying an offset to the first time difference, wherein the offset accounts for a difference in transmit times between the first reference signal and the second reference signal. In some cases, the offset is less than a threshold, and the threshold depends on at least one of a speed of the source BS or a speed of the target BS.

In some cases, operations 1500 further include transmitting an indication of the first time difference between the first reference signal associated with the source BS and the second reference signal associated with the target BS to at least one of the source BS or the target BS.

In some cases, obtaining the indication of the TA for communicating with the target BS comprises receiving the indication of the TA for communicating with the target BS from at least one of the source BS or the target BS.

In some cases, the indication of the TA for communicating with the target BS is based on a time of flight (ToF) between the source BS and the target BS.

In some cases, the indication of the TA for communicating with the target BS is received from the source BS. In some cases, the indication of the TA for communicating with the target BS comprises an indication of a second time difference between a transmit time associated with the first reference signal associated with source BS and a receive time of a third reference signal associated with the target BS at the source BS. In some cases, the indication of the TA for communicating with the target BS comprises a value representing a difference between a time of flight (ToF) between the source BS and the target BS, and a second time difference between a transmit time associated with the first reference signal associated with source BS and a receive time of a third reference signal associated with the target BS at the source BS.

In some cases, the indication of the TA for communicating with the target BS is received from the target BS. In some cases, the indication of the TA for communicating with the target BS comprises an indication of a second time difference between a transmit time associated with the second reference signal associated with target BS and a receive time of a third reference signal associated with the source BS at the target BS. In some cases, the indication of the TA for communicating with the target BS comprises a value representing a difference between: a time of flight (ToF) between the source BS and the target BS, and a second time difference between a transmit time associated with the second reference signal associated with target BS and a receive time of a third reference signal associated with the source BS at the target BS.

In some cases, operations 1500 further include receiving a message from the source BS including an indication of the second reference signal associated with the target BS. In some cases, the message comprises at least one of: the handover command, a media access control-control element (MAC-CE), or downlink control information (DCI). In some cases, the message further includes information triggering the UE to determine the first time difference between the first reference signal associated with the source BS and the second reference signal associated with the target BS. In some cases, the information triggering the UE to determine the first time difference includes a group identifier associated with a group of UEs, including the UE, and the group identifier depends on a transmission beam associated with the source BS.

In some cases, the source BS comprises a first non-terrestrial BS (NTBS) in a non-terrestrial network (NTN) and the target BS comprises a second NTBS in the NTN. In some cases, the source BS comprises a non-terrestrial BS (NTBS) in a non-terrestrial network (NTN) and the target BS comprises a BS in a terrestrial network. In some cases, the source BS comprises a BS in a terrestrial network and the target BS comprises a non-terrestrial BS (NTBS) in a non-terrestrial network (NTN). In some cases, the source BS comprises a BS in a terrestrial network and the target BS comprises a BS in a terrestrial network.

In some cases, operations 1500 further include performing, based on the handover command, a handover procedure to hand the UE over to the target BS.

In some cases, the one or more signals transmitted to the target BS comprise one of a radio resource control (RRC) reconfiguration complete message or a channel state information (CSI) report.

### Example Wireless Communication Devices

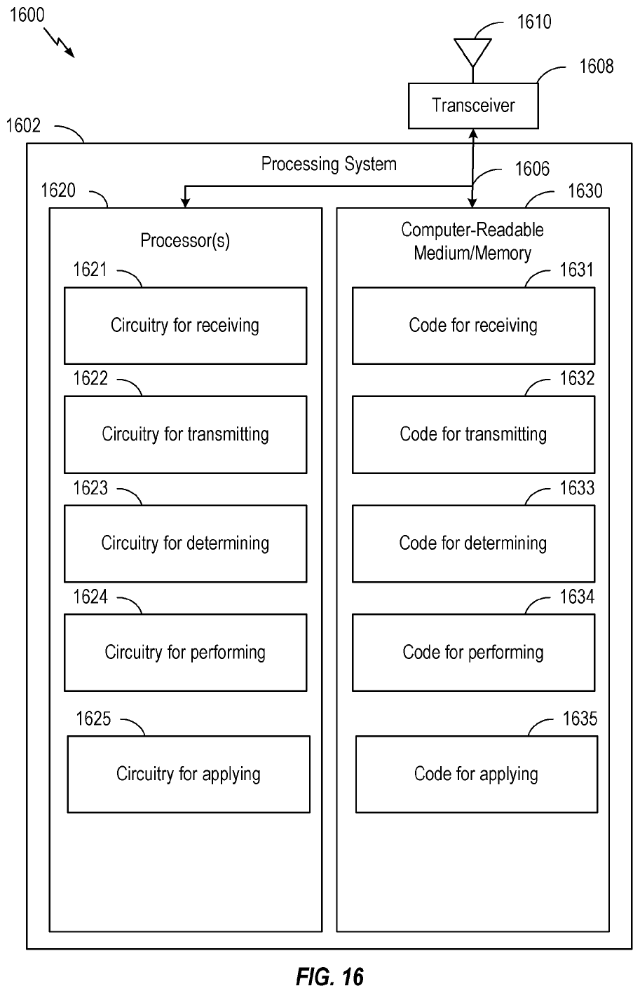

FIG. 16 depicts an example communications device 1600 that includes various components operable, configured, or adapted to perform operations for the techniques disclosed herein, such as the operations depicted and described with respect to FIGS. 7, 9, 11, 13, and 14. In some examples, communication device 1600 may be a BS 102 as described, for example with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIGS. 7, 9, 11, 13, and 14, or other operations for performing the various techniques discussed herein for determining a time advance for a handover in a non-terrestrial network.

In the depicted example, computer-readable medium/memory 1630 stores code 1631 for receiving, code 1632 for transmitting, code 1633 for determining, code 1634 for performing, and code 1635 for applying.

In the depicted example, the one or more processors 1620 include circuitry configured to implement the code stored in the computer-readable medium/memory 1630, including circuitry 1621 for receiving, circuitry 1622 for transmitting, circuitry 1623 for determining, circuitry 1624 for performing, and circuitry 1625.

Various components of communications device 1600 may provide means for performing the methods described herein, including with respect to FIGS. 7, 9, 11, 13, and 14.

In some examples, means for transmitting or sending (or means for outputting for transmission) may include the transceivers 232 and/or antenna(s) 234 of the BS 102 illustrated in FIG. 2 and/or transceiver 1608 and antenna 1610 of the communication device 1600 in FIG. 16.

In some examples, means for receiving (or means for obtaining) may include the transceivers 232 and/or antenna(s) 234 of the BS 102 illustrated in FIG. 2 and/or transceiver 1608 and antenna 1610 of the communication device 1600 in FIG. 16.

In some examples, means for performing, means for determining, and means for applying may include various processing system components, such as: the one or more processors 1620 in FIG. 16, or aspects of the BS 102 depicted in FIG. 2, including receive processor 238, transmit processor 220, TX MIMO processor 230, and/or controller/processor 240 (including handover component 241).

Notably, FIG. 16 is just one example, and many other examples and configurations of communication device 1600 are possible.

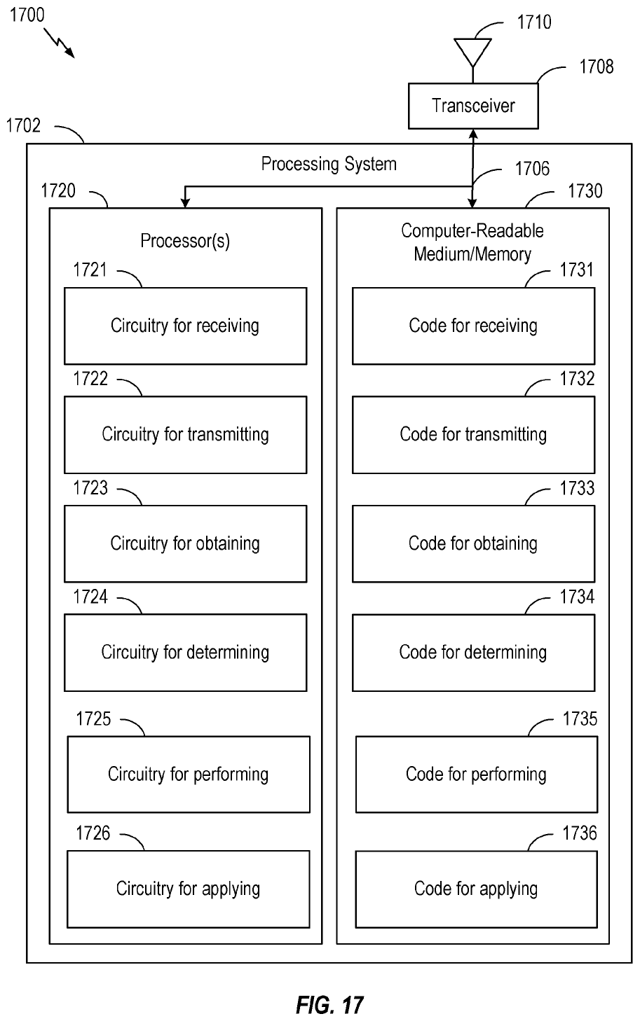

FIG. 17 depicts an example communications device 1700 that includes various components operable, configured, or adapted to perform operations for the techniques disclosed herein, such as the operations depicted and described with respect to FIGS. 7, 9, 11, and 15. In some examples, communication device 1700 may be a user equipment 104 as described, for example with respect to FIGS. 1 and 2.

Communications device 1700 includes a processing system 1702 coupled to a transceiver 1708 (e.g., a transmitter and/or a receiver). Transceiver 1708 is configured to transmit (or send) and receive signals for the communications device 1700 via an antenna 1710, such as the various signals as described herein. Processing system 1702 may be configured to perform processing functions for communications device 1700, including processing signals received and/or to be transmitted by communications device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIGS. 7, 9, 11, and 15, or other operations for performing the various techniques discussed herein for determining a time advance for a handover in a non-terrestrial network.

In the depicted example, computer-readable medium/memory 1730 stores code 1731 for receiving, code 1732 for transmitting, code 1733 for obtaining, code 1734 for determining, code 1735 for performing, and code 1736 for applying.

In the depicted example, the one or more processors 1720 include circuitry configured to implement the code stored in the computer-readable medium/memory 1730, including circuitry 1721 for receiving, circuitry 1722 for transmitting, circuitry 1723 for obtaining, circuitry 1724 for determining, circuitry 1725 for performing, and circuitry 1726 for applying.

Various components of communications device 1700 may provide means for performing the methods described herein, including with respect to FIGS. 7, 9, 11, and 15.

In some examples, means for transmitting or sending (or means for outputting for transmission) may include the transceivers 254 and/or antenna(s) 252 of the user equipment 104 illustrated in FIG. 2 and/or transceiver 1708 and antenna 1710 of the communication device 1700 in FIG. 17.

In some examples, means for receiving (or means for obtaining) may include the transceivers 254 and/or antenna(s) 252 of the user equipment 104 illustrated in FIG. 2 and/or transceiver 1708 and antenna 1710 of the communication device 1700 in FIG. 17.

In some examples, means for obtaining, means for determining, means for applying, and means for performing may include various processing system components, such as: the one or more processors 1720 in FIG. 17, or aspects of the user equipment 104 depicted in FIG. 2, including receive processor 258, transmit processor 264, TX MIMO processor 266, and/or controller/processor 280 (including handover component 281).

Notably, FIG. 17 is just one example, and many other examples and configurations of communication device 1700 are possible.

### EXAMPLE CLAUSES

Implementation examples are described in the following numbered clauses:
Clause 1: A method for wireless communication by a user equipment (UE), comprising: receiving, from a source base station (BS), a handover command instructing the UE to hand over to a target BS; obtaining an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS; and transmitting, based on the handover command, one or more signals to the target BS using the TA for communicating with the target BS.
Clause 2: The method of Clause 1, wherein: the first reference signal comprises one of synchronization signal blocks (SSBs), channel state information reference signals (CSI-RSs), or positioning reference signals (PRSs), and the second reference signal comprises one of SSBs, CSI-RSs, or PRSs.
Clause 3: The method of any one of Clauses 1-2, further comprising: receiving the first reference signal from the source BS at a first receive time; receiving the second reference signal from the target BS at a second receive time; and determining the first time difference between the first reference signal associated with the source BS and the second reference signal associated with the target BS based on the first receive time and the second receive time.
Clause 4: The method of Clause 3, wherein determining the first time difference between the first reference signal associated with the source BS and the second reference signal associated with the target BS based on the first receive time and the second receive time comprises determining a number of slots between the first receive time and the second receive time based on a subcarrier spacing associated with at least one of the source BS or the target BS.
Clause 5: The method of any one of Clauses 3-4, further comprising applying an offset to the first time difference, wherein the offset accounts for a difference in transmit times between the first reference signal and the second reference signal.
Clause 6: The method of Clause 5, wherein: the offset is less than a threshold, and the threshold depends on at least one of a speed of the source BS or a speed of the target BS.
Clause 7: The method of any one of Clauses 3-6, further comprising transmitting an indication of the first time difference between the first reference signal associated with the source BS and the second reference signal associated with the target BS to at least one of the source BS or the target BS.
Clause 8: The method of Clause 7, wherein obtaining the indication of the TA for communicating with the target BS comprises receiving the indication of the TA for communicating with the target BS from at least one of the source BS or the target BS.
Clause 9: The method of Clause 8, wherein the indication of the TA for communicating with the target BS is based on a time of flight (ToF) between the source BS and the target BS.
Clause 10: The method of Clause 8, wherein: the indication of the TA for communicating with the target BS is received from the source BS, and the indication of the TA for communicating with the target BS comprises one of: an indication of a second time difference between a transmit time associated with the first reference signal associated with source BS and a receive time of a third reference signal associated with the target BS at the source BS, or a value representing a difference between: a time of flight (ToF) between the source BS and the target BS, and a second time difference between a transmit time associated with the first reference signal associated with source BS and a receive time of a third reference signal associated with the target BS at the source BS.
Clause 11: The method of Clause 8, wherein: the indication of the TA for communicating with the target BS is received from the target BS, and the indication of the TA for communicating with the target BS comprises one of: an indication of a second time difference between a transmit time associated with the second reference signal associated with target BS and a receive time of a third reference signal associated with the source BS at the target BS, or a value representing a difference between: a time of flight (ToF) between the source BS and the target BS, and a second time difference between a transmit time associated with the second reference signal associated with target BS and a receive time of a third reference signal associated with the source BS at the target BS
Clause 12: The method of any one of Clauses 1-11, further comprising receiving a message from the source BS including an indication of the second reference signal associated with the target BS
Clause 13: The method of Clause 12, wherein the message comprises at least one of: the handover command, a media access control-control element (MAC-CE), or downlink control information (DCI).
Clause 14: The method of any one of Clauses 12-13, wherein the message further includes information triggering the UE to determine the first time difference between the first reference signal associated with the source BS and the second reference signal associated with the target BS.
Clause 15: The method of Clause 14, wherein the information triggering the UE to determine the first time difference includes a group identifier associated with a group of UEs, including the UE, and the group identifier depends on a transmission beam associated with the source BS.
Clause 16: The method of any one of Clauses 1-15, wherein one of: the source BS comprises a first non-terrestrial BS (NTBS) in a non-terrestrial network (NTN) and the target BS comprises a second NTBS in the NTN, the source BS comprises a non-terrestrial BS (NTBS) in a non-terrestrial network (NTN) and the target BS comprises a BS in a terrestrial network, or the source BS comprises a BS in a terrestrial network and the target BS comprises a non-terrestrial BS (NTBS) in a non-terrestrial network (NTN).
Clause 17: A method for wireless communication by a source base station (BS), comprising: transmitting, to a user equipment (UE), a handover command instructing the UE to hand over to a target BS; transmitting a first reference signal to the UE; receiving a second reference signal from the target BS; and transmitting, to the UE, an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.
Clause 18: The method of Clause 17, wherein the indication of the TA for communicating with the target BS is further based on a time of flight (ToF) between the source BS and the target BS.
Clause 19: The method of any one of Clauses 17-18, wherein: the first reference signal comprises one of synchronization signal blocks (SSBs), channel state information reference signals (CSI-RSs), or positioning reference signals (PRSs), and the second reference signal comprises one of an SSB, a CSI-RS, or a PRS.
Clause 20: The method of any one of Clauses 17-19, further comprising receiving, from the UE, an indication of a second time difference between a receive time of the first reference signal at the UE and a receive time of a third reference signal associated with the target BS at the UE, wherein the indication of the TA for communicating with the target BS is based further on the second time difference.
Clause 21: The method of any one of Clauses 17-20, wherein the indication of the TA for communicating with the target BS comprises one of: an indication of the first time difference between the transmit time of the first reference signal and the receive time of the second reference signal, or a value representing a difference between: a time of flight (ToF) between the source BS and the target BS, and an indication of the first time difference between the transmit time of the first reference signal and the receive time of the second reference signal.
Clause 22: The method of any one of Clauses 17-21, further comprising transmitting a message to the UE including an indication of a third reference signal associated with the target BS.
Clause 23: The method of Clause 22, wherein the message comprises at least one of: the handover command, a media access control-control element (MAC-CE), or downlink control information (DCI).
Clause 24: The method of any one of Clauses 22-23, wherein the message further includes information configured to cause the UE to determine a second time difference between the first reference and the third reference signal associated with the target BS
Clause 25: The method of Clause 24, wherein the information configured to cause the UE to determine the first time difference includes a group identifier associated with a group of UEs, including the UE, and the group identifier depends on a transmission beam associated with the source BS.
Clause 26: The method of any one of Clauses 17-25, further comprising determining the first time difference between the transmit time of the first reference signal and the receive time of the second reference signal.
Clause 27: The method of Clause 26, further comprising applying an offset to the first time difference, wherein the indication of the TA for communicating with the target BS is based further on the applied offset.
Clause 28: The method of any one of Clauses 26-27, wherein determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.
Clause 29: The method of any one of Clauses 17-28, wherein one of: the source BS comprises a first non-terrestrial BS (NTBS) in a non-terrestrial network (NTN) and the target BS comprises a second NTBS in the NTN, the source BS comprises a non-terrestrial BS (NTBS) in a non-terrestrial network (NTN) and the target BS comprises a BS in a terrestrial network, or the source BS comprises a BS in a terrestrial network and the target BS comprises a non-terrestrial BS (NTBS) in a non-terrestrial network (NTN).
Clause 30: The method of any one of Clauses 17-29, further comprising performing, based on the handover command, a handover procedure to hand the UE over to the target BS.
Clause 31: A method for wireless communication by a target base station (BS), comprising: receiving an indication of a handover of a user equipment (UE) from a source BS to the target BS; transmitting a first reference signal to the UE; receiving a second reference signal from the source BS; and transmitting an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.
Clause 32: The method of Clause 31, wherein the indication of the TA for communicating with the target BS is further based on a time of flight (ToF) between the source BS and the target BS
Clause 33: The method of any one of Clauses 31-32, wherein: the first reference signal comprises one of synchronization signal blocks (SSBs), channel state information reference signals (CSI-RSs), or positioning reference signals (PRSs), and the second reference signal comprises one of an SSB, a CSI-RS, or a PRS.
Clause 34: The method of any one of Clauses 31-22, further comprising receiving, from the UE, an indication of a second time difference between a receive time of the first reference signal at the UE and a receive time of a third reference signal associated with the source BS at the UE, wherein the indication of the TA for communicating with the target BS is based further on the second time difference.
Clause 35: The method of any one of Clauses 31-34, wherein the indication of the TA for communicating with the target BS comprises one of: an indication of the first time difference between the transmit time of the first reference signal and the receive time of the second reference signal, or a value representing a difference between: a time of flight (ToF) between the source BS and the target BS, and an indication of the first time difference between the transmit time of the first reference signal and the receive time of the second reference signal.
Clause 36: The method of any one of Clauses 31-36, further comprising determining the first time difference between the transmit time of the first reference signal and the receive time of the second reference signal.
Clause 37: The method of Clause 36, further comprising applying an offset to the first time difference, wherein the indication of the TA for communicating with the target BS is based further on the applied offset.
Clause 38: The method of any one of Clauses 36-37, wherein determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.
Clause 39: The method of any one of Clauses 31-38, wherein one of: the source BS comprises a first non-terrestrial BS (NTBS) in a non-terrestrial network (NTN) and the target BS comprises a second NTBS in the NTN, the source BS comprises a non-terrestrial BS (NTBS) in a non-terrestrial network (NTN) and the target BS comprises a BS in a terrestrial network, or the source BS comprises a BS in a terrestrial network and the target BS comprises a non-terrestrial BS (NTBS) in a non-terrestrial network (NTN).
Clause 40: The method of any one of Clauses 31-39, further comprising performing, based on the handover command, a handover procedure to hand the UE over to the target BS.
Clause 41: An apparatus, comprising: a memory comprising executable instructions; and one or more processors configured to execute the executable instructions and cause the apparatus to perform a method in accordance with any one of Clauses 1-40.
Clause 42: An apparatus, comprising means for performing a method in accordance with any one of Clauses 1-40.
Clause 43: A non-transitory computer-readable medium comprising executable instructions that, when executed by one or more processors of an apparatus, cause the apparatus to perform a method in accordance with any one of Clauses 1-40.
Clause 44: A computer program product embodied on a computer-readable storage medium comprising code for performing a method in accordance with any one of Clauses 1-40.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

In some cases, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). In some cases, BSs 102 configured for 5G (e.g., 5G NR or Next Generation RAN (NG-RAN)) may interface with 5GC 190 through second backhaul links 184. Additionally, in some cases, BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mm Wave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

In some cases, communication between UEs 104 and 5GC 190 may be facilitated by a non-terrestrial (NT) device, such as satellite 140. Satellite 140 may communicate with BSs 102/180 and UEs 104. In some cases, satellite 140 may have a backhaul link 184 to the 5GC 190 or may interface with the 5GC via BS 102. Satellite 140 may be any suitable type of communication satellite configured to relay communications between different end nodes in a wireless communication network. Satellite 140 may be an example of a space satellite, a balloon, a dirigible, an airplane, a drone, an unmanned aerial vehicle, and/or the like. In some examples, the satellite 140 may be in a geosynchronous or geostationary Earth orbit, a low Earth orbit or a medium Earth orbit. Satellite 140 may be a multi-beam satellite configured to provide service for multiple service beam coverage areas in a predefined geographical service area. The satellite 140 may be any distance away from the surface of the Earth.

In some cases, a cell 110 may be provided or established by a satellite 140 as part of a non-terrestrial network. Satellite 140 may, in some cases, perform the functions of a BS 102, act as a bent-pipe satellite, or may act as a regenerative satellite, or a combination thereof. In other cases, satellite 140 may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit/relay those signals to different ground stations. In some cases, a bent-pipe transponder or satellite may amplify signals or shift from uplink frequencies to downlink frequencies. For example, a bent-pipe satellite (e.g., satellite 140) may receive a signal from a BS 102 and may relay the signal to a UE 104 or another BS 102, or vice-versa. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS) The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of determining a timing advance (TA) for a handover in a network, such as a non-terrestrial network (NTN). The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
receiving, from a source base station (BS), a handover command instructing the UE to hand over to a target BS;
obtaining an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS; and
transmitting, based on the handover command, one or more signals to the target BS using the TA for communicating with the target BS.

2. The method of claim 1, wherein:
the first reference signal comprises one of synchronization signal blocks (SSBs), channel state information reference signals (CSI-RSs), or positioning reference signals (PRSs), and
the second reference signal comprises one of SSBs, CSI-RSs, or PRSs.

3. The method of claim 1, further comprising:
receiving the first reference signal from the source BS at a first receive time;
receiving the second reference signal from the target BS at a second receive time; and
determining the first time difference between the first reference signal associated with the source BS and the second reference signal associated with the target BS based on the first receive time and the second receive time.

4. The method of claim 3, wherein determining the first time difference between the first reference signal associated with the source BS and the second reference signal associated with the target BS based on the first receive time and the second receive time comprises determining a number of slots between the first receive time and the second receive time based on a subcarrier spacing associated with at least one of the source BS or the target BS.

5. The method of claim 3, further comprising applying an offset to the first time difference, wherein:
the offset accounts for a difference in transmit times between the first reference signal and the second reference signal,
the offset is less than a threshold, and
the threshold depends on at least one of a speed of the source BS or a speed of the target BS.

6. The method of claim 3, further comprising transmitting an indication of the first time difference between the first reference signal associated with the source BS and the second reference signal associated with the target BS to at least one of the source BS or the target BS, wherein obtaining the indication of the TA for communicating with the target BS comprises receiving the indication of the TA for communicating with the target BS from at least one of the source BS or the target BS.

7. The method of claim 6, wherein the indication of the TA for communicating with the target BS is based on a time of flight (ToF) between the source BS and the target BS.

8. The method of claim 6, wherein:
the indication of the TA for communicating with the target BS is received from the source BS, and
the indication of the TA for communicating with the target BS comprises one of:
an indication of a second time difference between a transmit time associated with the first reference signal associated with source BS and a receive time of a third reference signal associated with the target BS at the source BS, or
a value representing a difference between:
a time of flight (ToF) between the source BS and the target BS, and
a second time difference between a transmit time associated with the first reference signal associated with source BS and a receive time of a third reference signal associated with the target BS at the source BS.

9. The method of claim 6, wherein:
the indication of the TA for communicating with the target BS is received from the target BS, and
the indication of the TA for communicating with the target BS comprises one of:
an indication of a second time difference between a transmit time associated with the second reference signal associated with target BS and a receive time of a third reference signal associated with the source BS at the target BS, or
a value representing a difference between:
a time of flight (ToF) between the source BS and the target BS, and
a second time difference between a transmit time associated with the second reference signal associated with target BS and a receive time of a third reference signal associated with the source BS at the target BS.

10. The method of claim 1, further comprising receiving a message from the source BS including an indication of the second reference signal associated with the target BS.

11. The method of claim 10, wherein the message further includes information triggering the UE to determine the first time difference between the first reference signal associated with the source BS and the second reference signal associated with the target BS.

12. The method of claim 11, wherein the information triggering the UE to determine the first time difference includes a group identifier associated with a group of UEs, including the UE, and the group identifier depends on a transmission beam associated with the source BS.

13. A method for wireless communication by a source base station (BS), comprising:
transmitting, to a user equipment (UE), a handover command instructing the UE to hand over to a target BS;
transmitting a first reference signal to the UE;
receiving a second reference signal from the target BS; and
transmitting, to the UE, an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

14. The method of claim 13, wherein the indication of the TA for communicating with the target BS is further based on a time of flight (ToF) between the source BS and the target BS.

15. The method of claim 13, wherein:
the first reference signal comprises one of synchronization signal blocks (SSBs), channel state information reference signals (CSI-RSs), or positioning reference signals (PRSs), and
the second reference signal comprises one of an SSB, a CSI-RS, or a PRS.

16. The method of claim 13, further comprising receiving, from the UE, an indication of a second time difference between a receive time of the first reference signal at the UE and a receive time of a third reference signal associated with the target BS at the UE, wherein the indication of the TA for communicating with the target BS is based further on the second time difference.

17. The method of claim 13, wherein the indication of the TA for communicating with the target BS comprises one of:
an indication of the first time difference between the transmit time of the first reference signal and the receive time of the second reference signal, or
a value representing a difference between:
a time of flight (ToF) between the source BS and the target BS, and
an indication of the first time difference between the transmit time of the first reference signal and the receive time of the second reference signal.

18. The method of claim 13, further comprising transmitting a message to the UE including an indication of a third reference signal associated with the target BS, wherein the message further includes information configured to cause the UE to determine a second time difference between the first reference and the third reference signal associated with the target BS.

19. The method of claim 18, wherein the information configured to cause the UE to determine the first time difference includes a group identifier associated with a group of UEs, including the UE, and the group identifier depends on a transmission beam associated with the source BS.

20. The method of claim 13, further comprising determining the first time difference between the transmit time of the first reference signal and the receive time of the second reference signal.

21. The method of claim 20, further comprising applying an offset to the first time difference, wherein the indication of the TA for communicating with the target BS is based further on the applied offset.

22. The method of claim 20, wherein determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.

23. A method for wireless communication by a target base station (BS), comprising:
receiving an indication of a handover of a user equipment (UE) from a source BS to the target BS;
transmitting a first reference signal to the UE;
receiving a second reference signal from the source BS; and
transmitting an indication of a timing advance (TA) for communicating with the target BS, wherein the indication of the TA for communicating with the target BS is based, at least in part, on a TA used for communicating with the source BS and a first time difference between a transmit time of the first reference signal and a receive time of the second reference signal.

24. The method of claim 23, wherein the indication of the TA for communicating with the target BS is further based on a time of flight (ToF) between the source BS and the target BS.

25. The method of claim 23, wherein:
the first reference signal comprises one of synchronization signal blocks (SSBs), channel state information reference signals (CSI-RSs), or positioning reference signals (PRSs), and
the second reference signal comprises one of an SSB, a CSI-RS, or a PRS.

26. The method of claim 23, further comprising receiving, from the UE, an indication of a second time difference between a receive time of the first reference signal at the UE and a receive time of a third reference signal associated with the source BS at the UE, wherein the indication of the TA for communicating with the target BS is based further on the second time difference.

27. The method of claim 23, wherein the indication of the TA for communicating with the target BS comprises one of:
an indication of the first time difference between the transmit time of the first reference signal and the receive time of the second reference signal, or
a value representing a difference between:
a time of flight (ToF) between the source BS and the target BS, and
an indication of the first time difference between the transmit time of the first reference signal and the receive time of the second reference signal.

28. The method of claim 23, further comprising:
determining the first time difference between the transmit time of the first reference signal and the receive time of the second reference signal; and
applying an offset to the first time difference, wherein the indication of the TA for communicating with the target BS is based further on the applied offset.

29. The method of claim 28, wherein determining the first time difference between the transmit time of the first reference signal and the receive time of the second reference signal comprises determining, based on a subcarrier spacing associated with at least one of the source BS or the target BS, a number of slots between the transmit time of the first reference signal and the receive time of the second reference signal.

30. An apparatus for wireless communication, comprising:
a memory comprising executable instructions; and
one or more processors configured to execute the executable instructions and cause the apparatus to:
receive, from a source base station (BS), a handover command instructing the UE to hand over to a target BS;
obtain an indication of a timing advance (TA) for communicating with the target BS, wherein the indication of the TA for communicating with the target BS is based, at least in part, on a TA used for communicating with the source BS and a first time difference between a first reference signal associated with the source BS and a second reference signal associated with the target BS; and
transmit, based on the handover command, one or more signals to the target BS using the TA for communicating with the target BS.
